(19) United States
(12) Patent Application Publication
(10) Pub. No.: US 2026/0154737 A1
(43) Pub. Date: Jun. 4, 2026

(54) Climate Impact Analytics Using Smart Contracts Leveraging COA (Control Object Algorithm) and Sliding Window Algorithm (SWA)

(71) Applicant: Bank of America Corporation, Charlotte, NC (US)

(72) Inventors: Daniel Crowley, Charlotte, NC (US); Saurabh Garg, Faridabad (IN); Maneesh Kumar Sethia, Hyderabad (IN); Nisha Kumari, Hyderabad (IN)

(21) Appl. No.: 18/965,674

(22) Filed: Dec. 2, 2024

(51) Int. Cl. G06Q 40/03; G06Q 30/018; G06Q 50/16; G06V 10/82; G06V 20/10

(52) U.S. Cl. CPC G06Q 40/03; G06Q 30/018; G06Q 50/16; G06V 10/82; G06V 20/188

(57) ABSTRACT

Systems and methods automate evaluation of loans and mortgages by leveraging smart contracts, control object algorithms, sliding window algorithms, and artificial neural networks. The invention addresses challenges in traditional property evaluations, which are often prone to human error, bias, and inefficiencies due to manual processes. By utilizing smart contracts, the system automates the secure exchange of data between various financial modules and machine learning algorithms to evaluate properties based on environmental factors such as temp, humidity, rainfall, and wind speeds. The sliding window algorithm optimizes the data processing efficiency, reducing computational complexity. The system also incorporates a generative adversarial neural network to simulate secure network configurations for enhanced performance and security. Through the integration of digital land records and property-specific data, the system evaluates both urban and rural dynamics, providing a more accurate and unbiased real-time score for green loans and mortgages, ensuring scalability, security, and compliance with international standards.

### TECHNICAL FIELD

The inventions disclosed herein pertain to the field of artificial intelligence, particularly the use of machine learning techniques and neural networks for processing climate, environmental, and land-specific data. This includes utilizing artificial neural networks (ANNs) and generative adversarial neural networks (GANs) for simulating property evaluation processes, generating real-time predictions, and performing data-driven decision-making tasks related to loan and mortgage evaluations.

### DESCRIPTION OF THE RELATED ART

When financial institutions, such as banks, are tasked with evaluating the value of land or property for loans or mortgages, they often rely on manual processes that are vulnerable to human error. Bank executives or evaluators may miss critical details during assessments, such as environmental factors or historical climate conditions that can significantly impact the property's current and future value. The accuracy of property valuations is crucial for determining the appropriate loan amount, yet traditional evaluation methods often fail to consider the full spectrum of relevant data. These methods typically depend on the subjective judgment of the evaluator, leaving room for inconsistencies and inaccuracies in the assessment.

One of the significant challenges in evaluating properties lies in the influence of environmental conditions. Factors such as temp, humidity, rainfall, wind speeds, and overall climate history can affect both the value of the land and its potential for future development. These factors are often overlooked or incompletely considered, particularly when evaluators lack access to real-time or historical climate data. Furthermore, urban-rural dynamics, such as population density, economic activity, and infrastructure development, are essential components of property valuation, yet they are frequently assessed through general observations rather than data-driven analysis.

Another complication in the property evaluation process is the inherent bias introduced by human evaluators. Personal judgments can skew assessments, leading to discrepancies between evaluations of similar properties. Inconsistent evaluations can result in unfair loan amounts or misguided financial decisions, creating risks for both the lender and the borrower. Additionally, these biases can lead to unequal treatment of borrowers, as evaluators may unconsciously weigh certain factors more heavily based on subjective experience rather than objective data.

The property valuation process also faces inefficiencies due to the time required for manual evaluations. Bank executives must often travel to the property site, conduct on-site assessments, and manually collect the necessary information. This time-consuming process can delay loan approvals, causing frustration for borrowers who need quick access to funds. Furthermore, this process requires significant human resources, increasing operational costs for financial institutions. The lack of automation in property evaluations further exacerbates these delays, making it difficult for banks to process a high volume of loan applications efficiently.

Compounding these issues is the challenge of accessing and analyzing historical data on environmental conditions and property characteristics. Many banks do not have a streamlined system for retrieving comprehensive datasets, such as historical weather patterns or digital land records, which are critical for accurate property assessments. In many cases, such data must be manually retrieved from multiple sources, introducing the potential for data entry errors and further slowing the evaluation process. Without an integrated system that pulls together relevant data from various sources, banks struggle to perform holistic assessments that account for all factors affecting property value.

In addition to these challenges, banks are increasingly faced with the need to assess the sustainability and environmental impact of properties, particularly for green loans and mortgages. Properties that adhere to sustainable practices or have a minimal environmental impact are becoming more desirable, both for borrowers and lenders. However, traditional property evaluation methods do not account for such factors, leaving banks unable to provide an accurate assessment of a property's environmental footprint. This gap in evaluation methods leaves financial institutions ill-equipped to promote sustainable lending practices, despite growing demand for environmentally friendly investment options.

There is also the issue of inconsistent access to data on urban and rural development. Properties located in rural areas often lack up-to-date information on infrastructure, land use, and economic activity, making it difficult for evaluators to accurately assess their value. Similarly, urban properties may experience rapid changes in their surroundings, such as new developments or population growth, that can significantly alter their value in a short period. Without access to real-time data on such developments, banks may provide outdated or inaccurate property valuations, leading to financial risk.

Moreover, property records and digital land data are often stored in separate systems that do not communicate effectively. This lack of integration makes it challenging for banks to obtain a complete picture of the property being evaluated. Manual processes for gathering these records can be error-prone, resulting in incomplete or incorrect information being used in the valuation process. Furthermore, the security of sensitive data, such as property records and personal financial information, is often compromised by outdated or insufficient security measures, increasing the risk of fraud and data breaches during the evaluation process.

Loan and mortgage evaluation processes are also vulnerable to external factors such as market fluctuations, regulatory changes, and environmental disasters, which can drastically alter property values. Banks often lack the tools to dynamically adjust property valuations in response to these changes, leading to inaccurate assessments that do not reflect the current market or environmental conditions. This inflexibility creates a significant risk for financial institutions, as loans based on incorrect property values can lead to losses if the property's true value declines after the loan is issued.

The complexity of modern financial systems also means that banks must handle vast amounts of data from multiple sources. Integrating and analyzing this data in real time is a significant challenge, particularly when traditional methods rely on manual processes. The inability to process large datasets efficiently hampers banks' ability to make timely decisions, further slowing down the loan approval process. Additionally, the lack of advanced data analytics tools limits banks' capacity to predict future trends in property value, leading to reactive rather than proactive decision-making.

The fragmentation of data systems also poses a problem for compliance with regulatory requirements. Financial institutions are required to maintain accurate records of property valuations and loan assessments, but the manual nature of traditional evaluations makes it difficult to ensure compliance with these regulations. Inaccurate or incomplete records can lead to legal and financial consequences, further increasing the risk for banks. Moreover, the lack of transparency in the evaluation process can create trust issues between the bank and the borrower, as borrowers may not understand how their property's value was determined.

The evaluation of properties in diverse geographical locations adds another layer of complexity. Different regions may have varying environmental, economic, and legal factors that affect property value, making it challenging for banks to apply a consistent evaluation methodology across all locations. Without a system that accounts for regional differences in a standardized manner, banks may provide inconsistent loan amounts, creating disparities between borrowers in different areas.

Furthermore, the reliance on outdated technology in many financial institutions exacerbates the challenges in property evaluation. Legacy systems are often not equipped to handle modern data processing needs, such as the integration of machine learning algorithms or the use of smart contracts. These systems may also lack the flexibility to adapt to new regulatory requirements or market conditions, leaving banks at a disadvantage when trying to innovate in the loan evaluation process. This technological gap creates inefficiencies that prevent financial institutions from responding to the demands of a rapidly changing financial landscape.

Financial institutions are under increasing pressure to reduce operational costs while maintaining accuracy and speed in loan processing. Traditional methods of property evaluation require significant human and financial resources, creating a bottleneck in the loan approval process. Banks must find ways to streamline their operations without sacrificing the accuracy of property valuations, but current methods offer few solutions to this problem.

The long-felt and unmet need for this invention arises from the banking industry's continued reliance on manual, error-prone methods for property evaluation. For decades, banks have struggled with the inefficiencies and inaccuracies inherent in traditional evaluation processes, particularly when it comes to integrating environmental factors and urban-rural dynamics into loan decisions. Despite advancements in data analytics and machine learning, no comprehensive system has yet emerged to automate and optimize property evaluations in a way that addresses all these factors holistically. This invention fills that gap by providing a solution that not only improves the accuracy and speed of property evaluations but also enhances the security and scalability of the process.

### SUMMARY OF THE INVENTION

The disclosed invention introduces a system that significantly enhances the process of evaluating loans and mortgages by automating various steps that have traditionally relied on manual labor, prone to human error. The complexity of property evaluation often involves assessing numerous factors such as geographical data, environmental conditions, and historical trends. This invention addresses these complexities by integrating advanced technologies such as machine learning, smart contracts, and secure data transmission protocols. The system's core architecture is designed to provide a comprehensive evaluation that minimizes the need for human intervention while improving accuracy, efficiency, and security.

At the core of the system is the use of smart contracts, which serve as automated agents that manage the secure exchange of data between different system components. Smart contracts ensure that property-related data, such as land records, climate conditions, and property characteristics, are automatically retrieved, processed, and stored without the risk of human error. This automation is key to the invention's efficiency, as it removes the need for bank employees to manually handle large amounts of data or make subjective judgments during the evaluation process. The smart contracts are programmed to interact with various algorithms that analyze the data, providing an objective and data-driven evaluation of the property's value.

A significant aspect of the invention is the Control Object Algorithm (COA), which acts as the central controller for data routing within the system. The COA is responsible for managing how data flows between different processing modules and ensuring that the correct datasets are analyzed by the appropriate machine learning algorithms. This algorithm helps maintain the system's efficiency and effectiveness, as it eliminates potential bottlenecks by directing data where it is needed without delays. By controlling data flow, the COA enables the system to quickly analyze factors such as climate data, urbanization levels, and land use patterns, all of which play a role in determining a property's value.

To further enhance the processing capabilities, the invention employs a Sliding Window Algorithm (SWA). This algorithm is designed to handle time-series data, such as continuous streams of climate information, in a highly efficient manner. The SWA reduces computational complexity by transforming nested loops into a single loop, significantly improving processing speeds. This optimization is particularly important when dealing with large datasets or real-time data, where traditional methods might struggle to keep up with the volume and speed of information. By utilizing the SWA, the system can process real-time environmental data such as temp, humidity, wind speed, and rainfall, all of which are factors in assessing the potential future value of a property.

Artificial Neural Networks (ANN) are integrated into the system to provide deep learning capabilities, allowing the system to predict trends and make informed decisions based on historical and real-time data. The ANN is especially useful for analyzing complex datasets where traditional algorithms might fall short. For instance, environmental factors that influence property values can be subtle and interconnected, requiring sophisticated analysis to identify patterns and predict future outcomes. The ANN uses a backpropagation approach, a method that allows the network to continually refine its predictions by learning from errors in previous predictions. This enables the system to improve its accuracy over time, ensuring that property evaluations become more precise with each use.

The system also features a Generative Adversarial Neural Network (GAN), which plays a pivotal role in enhancing the security and performance of the overall architecture. The GAN is used to simulate various network configurations, enabling the system to assess different data transfer scenarios and optimize for security, performance, and data redundancy. This ensures that the system is resilient to potential security breaches or data losses, a critical consideration for financial institutions handling sensitive information such as property records and personal financial data. The GAN operates by generating artificial scenarios to test the system's defenses, ensuring that it remains robust even under challenging conditions.

One of the core inventive features of the invention is its integration of environmental data into the property evaluation process. The system gathers and analyzes a wide range of environmental factors, including temp variations, wind patterns, humidity levels, and rainfall history, through the Climate Environment Information Processing Module. This module applies the sliding window algorithm to handle continuous streams of climate data, ensuring that the most up-to-date information is used in the evaluation. By incorporating climate data into the property assessment, the system provides a more comprehensive evaluation than traditional methods, which often overlook these crucial factors. The inclusion of this data allows financial institutions to better understand the long-term risks associated with a property, particularly in areas prone to environmental changes or extreme weather events.

The invention also includes an Urban/Rural Processing Module, which evaluates properties based on their geographical location and the level of urbanization or rurality. This module analyzes data such as population density, economic activity, and land use patterns to determine how the property's surroundings may impact its value. Urban properties, for example, may be subject to higher demand and faster appreciation in value due to infrastructure development and population growth, while rural properties might have different dynamics related to land use and economic potential. The system accounts for these differences, providing an evaluation that is tailored to the specific characteristics of the property's location.

In addition to evaluating urban and rural factors, the system incorporates a Township Processing Module, which ensures that all necessary legal and regulatory information is considered during the property evaluation. This module retrieves property records from government databases and verifies that the property complies with local regulations and standards. It also checks for potential fraud or discrepancies in the documentation, leveraging international standards such as IEC 27001 for data security. By automating the retrieval and verification of property records, the system reduces the risk of errors and ensures that all relevant information is included in the evaluation process.

To ensure secure and efficient communication between the system's components, the invention utilizes the MQTT protocol, a lightweight messaging protocol designed for low-bandwidth, low-latency environments. MQTT is particularly well-suited for transmitting data between the bank's servers, the smart contract system, and the machine learning modules, ensuring that data is transferred securely and efficiently. The use of MQTT allows the system to handle large volumes of data without compromising on performance, making it ideal for financial institutions that require fast and reliable communication across multiple systems.

Security is a key consideration in the invention, and this is addressed through the inclusion of a Secure Access Service Edge (SASE). The SASE monitors and controls access to the system, ensuring that only authorized users can interact with sensitive financial data. This layer of security is further enhanced by micro-segmentation techniques, which divide the network into smaller, isolated segments, reducing the risk of unauthorized access to sensitive data. The use of SASE and micro-segmentation ensures that the system remains secure and compliant with data privacy regulations, which is crucial for financial institutions handling confidential customer information.

The invention's network architecture is built on a spine-leaf topology, a highly scalable and reliable network configuration that connects the various system components, including the machine learning modules, smart contracts, and property databases. The spine-leaf topology provides high-speed data transfers and minimizes latency, enabling the system to process multiple property evaluations simultaneously. This scalability is essential for financial institutions that handle a high volume of loan applications, as it ensures that the system can efficiently manage large datasets without delays or performance issues.

Digital end-to-end transactions are another key feature of the invention, ensuring that all data related to the property evaluation is securely processed and transmitted throughout the entire transaction lifecycle. This feature allows banks to maintain a secure record of the evaluation process, ensuring compliance with data privacy regulations and reducing the risk of fraud. The integration of digital transaction capabilities with machine learning and smart contracts provides a seamless and secure process for evaluating loans and mortgages, improving the efficiency and accuracy of the entire transaction.

The invention also includes mechanisms to adapt to changing environmental and market conditions. The machine learning algorithms used in the system are designed to continuously learn from new data, enabling the system to adjust its evaluations in response to new information. For example, if a property's surrounding area experiences rapid urban development or significant changes in climate conditions, the system can factor these changes into its evaluation. This adaptability is important for financial institutions, as it allows them to make proactive decisions based on the most current data, reducing the risk of inaccurate evaluations due to outdated information.

Operational efficiency is another major benefit of the invention. By automating the property evaluation process, the system significantly reduces the time and resources required to process loan applications. Banks no longer need to rely on manual evaluations, which can be time-consuming and prone to error. Instead, the system provides fast, accurate evaluations that can be completed in a fraction of the time, allowing banks to process more applications in less time. This not only reduces operational costs but also improves customer satisfaction by speeding up the loan approval process.

In conclusion, the invention offers a robust, secure, and efficient solution for automating the evaluation of loans and mortgages. Through the integration of smart contracts, control object algorithms, sliding window algorithms, artificial neural networks, and generative adversarial neural networks, the system provides a comprehensive and data-driven evaluation process. By factoring in environmental data, urban-rural differentiation, and secure messaging protocols, the invention ensures that financial institutions can make informed, accurate, and secure loan and mortgage decisions. This invention represents a significant advancement in the field of financial technology, providing a solution that addresses the challenges of traditional property evaluation methods while offering enhanced scalability, security, and operational efficiency.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a climate-impact analytics system for evaluating loans and mortgages comprises a control object algorithm configured to manage data flow between various system components. The control object algorithm routes property data and environmental data to appropriate processing modules for analysis. The system further includes a sliding window algorithm configured to process continuous streams of time-series data, such as temp, humidity, rainfall, and wind speed data. The sliding window algorithm reduces computational complexity by optimizing data analysis. Additionally, a smart contract module is provided, which automates secure data exchanges between financial institution systems and external data sources, facilitating real-time data processing and decision-making for property evaluations. An artificial neural network is configured to analyze and predict trends based on historical and real-time environmental data, using a backpropagation approach to improve accuracy over time. A generative adversarial neural network simulates network configurations and optimizes system performance while ensuring secure and resilient data transmission throughout the system. A climate environment information processing module integrates and analyzes environmental factors by applying the sliding window algorithm to handle continuous climate data streams, generating a comprehensive evaluation of the property's environmental conditions.

The system further includes an urban/rural processing module configured to assess population density, economic activity, and land use patterns, adjusting the property evaluation based on urbanization or rurality factors. A township processing module retrieves and verifies property registration records from government databases, ensuring compliance with legal and regulatory standards, and identifying potential fraud or documentation discrepancies. The system includes a secure messaging protocol, using the MQTT protocol, to transmit data between a bank server, the smart contract module, and machine learning modules, ensuring secure and efficient communication during the property evaluation process. A secure access service edge (SASE) monitors and controls access to the system, enforcing permissions and utilizing micro-segmentation techniques to protect sensitive financial and property-related data. Finally, the system incorporates a spine-leaf network topology connecting the system components, including machine learning modules, smart contracts, and property databases, providing scalable, high-speed data transfers while minimizing latency. Additionally, a digital end-to-end transaction system processes and stores all data related to property evaluations, ensuring secure handling from initial input to the final loan or mortgage decision.

In some arrangements, the system further comprises the control object algorithm dynamically adjusting the routing of data based on the type of property being evaluated, including residential, commercial, industrial, or agricultural properties, ensuring that the appropriate modules are engaged for specialized evaluation.

In some arrangements, the system further comprises the sliding window algorithm incorporating seasonal variations in climate data, allowing the system to provide more accurate predictions of environmental impact on property values during different times of the year.

In some arrangements, the system further comprises the smart contract module integrating with external regulatory databases to automatically retrieve and verify compliance with environmental laws and building codes, ensuring that property evaluations reflect any legal restrictions or considerations.

In some arrangements, the system further comprises the artificial neural network utilizing a multi-layered architecture that includes convolutional layers to process geospatial imagery of the property, providing additional context to the evaluation by analyzing land features such as topography, vegetation, and proximity to water bodies.

In some arrangements, the system further comprises the generative adversarial neural network generating synthetic environmental scenarios, such as extreme weather events, to assess the property's resilience, adjusting the evaluation based on potential future environmental risks.

In some arrangements, the system further comprises the climate environment information processing module receiving real-time updates from environmental monitoring systems, allowing for continuous reassessment of the property's value based on the latest climate data.

In some arrangements, the system further comprises the urban/rural processing module assessing the infrastructure development trends in the surrounding area, including transportation networks, utilities, and commercial developments, and adjusting the property's evaluation based on potential future urbanization or rural preservation efforts.

In some arrangements, the system further comprises the township processing module verifying property boundaries and ownership history using blockchain-based land registry systems, ensuring that all property records are tamper-proof and that any title disputes are accounted for in the evaluation.

In some arrangements, the system further comprises the secure messaging protocol utilizing quantum-resistant encryption algorithms, ensuring that all communications within the system, including those involving external databases and regulatory systems, remain secure against future advancements in cryptography-breaking technologies.

In some arrangements, a method for evaluating loans and mortgages using a climate-impact analytics system comprises receiving, by the control object algorithm, property data and environmental data from various sources, and dynamically routing the data based on the type of property being evaluated, including residential, commercial, industrial, or agricultural properties, to appropriate processing modules for analysis. The method also includes processing, by the sliding window algorithm, continuous streams of time-series data, including temp, humidity, rainfall, and wind speed data, and reducing computational complexity by optimizing data analysis, while incorporating seasonal variations in climate data to predict environmental impacts on property values during different times of the year. Additionally, the method includes automating, by the smart contract module, secure data exchanges between financial institution systems and external data sources, and integrating with external regulatory databases to automatically retrieve and verify compliance with environmental laws and building codes during the property evaluation process.

The method involves analyzing, by the artificial neural network, historical and real-time environmental data to predict trends affecting property values, applying a backpropagation approach to improve evaluation accuracy over time, and utilizing convolutional layers to process geospatial imagery, thereby analyzing land features such as topography, vegetation, and proximity to water bodies. The method also includes generating, by the generative adversarial neural network, synthetic environmental scenarios, such as extreme weather events, to assess the property's resilience, and optimizing system performance by simulating network configurations to ensure secure and resilient data transmission.

The method integrates, by the climate environment information processing module, real-time updates from environmental monitoring systems with historical climate data, applying the sliding window algorithm to continuously reassess and generate a comprehensive evaluation of the property's environmental conditions. Additionally, the method assesses, by the urban/rural processing module, population density, economic activity, and land use patterns for properties, adjusting the property evaluation based on urbanization or rurality factors, while analyzing infrastructure development trends, including transportation networks and utilities, to assess future urbanization or rural preservation efforts.

The method retrieves and verifies, by the township processing module, property registration records from government databases, ensuring compliance with legal and regulatory standards, identifying potential fraud or documentation discrepancies, and verifying property boundaries and ownership history using blockchain-based land registry systems to ensure tamper-proof records and address any title disputes. The method transmits, by the secure messaging protocol using the MQTT protocol, data between a bank server, the smart contract module, and machine learning modules, ensuring secure and efficient communication during the property evaluation process, while applying quantum-resistant encryption algorithms to safeguard communications against future cryptography-breaking technologies. The method monitors and controls, by the secure access service edge (SASE), access to the system, enforcing permissions and utilizing micro-segmentation techniques to protect sensitive financial and property-related data during the evaluation process. The method connects, by the spine-leaf network topology, the system components, including machine learning modules, smart contracts, and property databases, providing scalable, high-speed data transfers and minimizing latency during the property evaluation process. Finally, the method processes, by the digital end-to-end transaction system, all data related to property evaluations, ensuring secure handling and storage of evaluation data from initial input to final loan or mortgage decision.

In some arrangements, the method further comprises dynamically adjusting, by the control object algorithm, the routing of data based on changes in the type of evaluation required for specialized property types, including environmentally protected land or disaster-prone areas, to ensure that the appropriate processing modules are engaged for the specific property type.

In some arrangements, the method further comprises incorporating, by the sliding window algorithm, long-term climate change data, including rising sea levels, increasing frequency of extreme weather events, and changing temp patterns, into the property evaluation process, predicting how future environmental risks may affect property values over the next 10 to 50 years, and providing a future risk assessment alongside the current evaluation.

In some arrangements, the method further comprises automatically retrieving, by the smart contract module, updates from local government agencies and regulatory bodies regarding new building codes, environmental restrictions, or zoning changes that may affect the evaluation of the property, and adjusting the evaluation accordingly to ensure compliance with the latest legal requirements.

In some arrangements, the method further comprises analyzing, by the artificial neural network, multi-spectral satellite imagery alongside geospatial data to detect changes in land cover, such as deforestation, soil degradation, water body shifts, and urban sprawl, and using these changes as key factors in determining the property's suitability for development, agricultural use, or other activities, thereby providing a more granular and precise evaluation of the property's value and risk profile.

In some arrangements, the method further comprises generating, by the generative adversarial neural network, multiple extreme environmental event scenarios, including natural disasters such as flooding, hurricanes, earthquakes, wildfires, and droughts, assessing how resilient the property is to each type of disaster, and adjusting the property value evaluation based on these simulations, including the costs of potential damages, recovery timelines, and insurance implications for each scenario.

In some arrangements, the method further comprises continuously updating, by the climate environment information processing module, the property evaluation with real-time climate data obtained from IoT-connected environmental sensors, satellite-based monitoring systems, and weather stations, allowing the system to dynamically adjust the evaluation to reflect current environmental conditions, such as air quality, real-time precipitation levels, and storm severity, and how these immediate factors may influence the property's value at any given time.

In some arrangements, the method further comprises assessing, by the urban/rural processing module, future infrastructure projects in the surrounding area, including planned expansions of road networks, public transportation, utility grids (such as electricity, water, and telecommunications), and other public services, using government and private sector data sources, and predicting how these developments will increase or decrease the property's future value, with particular focus on projected economic growth and urbanization trends.

In some arrangements, the method further comprises verifying, by the township processing module, the property's historical ownership records across multiple jurisdictions, using distributed ledger technology or blockchain-based land registry systems to ensure tamper-proof and transparent records, identifying any discrepancies or fraudulent claims in the ownership history, and providing an adjusted evaluation if any disputes or irregularities are detected in the title history, thereby ensuring the legal soundness of the property's ownership status before finalizing the loan or mortgage decision.

The following description and claims, in conjunction with the drawings-all integral parts of this specification-will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts a comprehensive system architecture for climate-impact analytics used to evaluate loans and mortgages, integrating various data processing modules such as AI, smart contracts, and secure messaging protocols. The system efficiently handles environmental, financial, and legal data to provide accurate, real-time property evaluations.

FIG. 2 depicts the data flow within a climate-impact analytics system for evaluating loans and mortgages, showing how data moves from the customer through various system components, including authentication, security, AI processing, and smart contracts. The diagram illustrates the interaction between modules responsible for retrieving, processing, securing, and analyzing both property and environmental data to produce an accurate evaluation.

FIG. 3 depicts a process flow diagram for the climate-impact analytics system used to evaluate loans and mortgages, showing the steps from data input by the customer through various stages of processing, security, and analysis. It outlines the flow of data between system components such as authentication, AI analysis, smart contracts, and environmental processing, leading to a final loan or mortgage decision.

FIGS. 4 and 5 collectively depict a sequence diagram outlining the interactions between various components of the climate-impact analytics system during the loan and mortgage evaluation process. It shows how data flows from the customer through authentication, AI analysis, smart contract automation, and environmental assessment, leading to a final loan or mortgage decision.

FIG. 6 depicts the interaction between various components of the climate-impact analytics system, highlighting the communication flow between smart contracts, machine learning algorithms, and environmental data processing modules. The figure emphasizes how the smart contract module interacts with the artificial neural network (ANN) and sliding window algorithm to automate decision-making based on real-time environmental data, while ensuring secure data transmission and compliance with legal standards.

### DETAILED DESCRIPTION

The invention presents a sophisticated climate-impact analytics system designed to evaluate loans and mortgages with heightened accuracy, efficiency, and security. The system uses advanced algorithms and machine learning techniques to assess the impact of environmental conditions on property values, providing financial institutions with real-time data and precise evaluations. By automating and optimizing the property evaluation process, the invention eliminates many of the human errors and biases associated with traditional methods. The core of the system lies in its ability to collect, process, and analyze large datasets related to climate conditions, property records, and urban or rural dynamics, all of which contribute to a property's overall valuation.

A central component of the system is the control object algorithm, which is responsible for managing data flow within the system. This algorithm dynamically routes property data and environmental information to the appropriate processing modules for further analysis. The control object algorithm plays a key role in ensuring that the system processes relevant information quickly and accurately based on the type of property being evaluated, whether residential, commercial, industrial, or agricultural. By automating this task, the system enhances operational efficiency and reduces the need for manual data handling.

The system also incorporates a sliding window algorithm that processes continuous streams of time-series data, such as temp, humidity, rainfall, and wind speed. This algorithm is optimized to handle large amounts of environmental data while minimizing computational complexity. The sliding window algorithm ensures that the system can quickly process real-time and historical climate data, allowing the evaluation to reflect current and future environmental conditions. Seasonal variations in climate are also accounted for, providing a comprehensive analysis that enhances the accuracy of property valuations.

A smart contract module is another aspect of the system. This module automates the secure exchange of data between financial institution systems and external data sources, such as regulatory bodies and environmental monitoring services. The smart contract module integrates seamlessly with external databases, automatically retrieving and verifying compliance with environmental laws, building codes, and other relevant regulations. By ensuring that property evaluations take into account legal and regulatory factors, the system provides a more complete and reliable assessment of the property's value.

One of the components of the system is the artificial neural network (ANN), which is tasked with analyzing and predicting trends in property value based on historical and real-time environmental data. The ANN applies a backpropagation approach to continually improve the accuracy of its predictions. It also incorporates convolutional layers to process geospatial imagery, adding context to the evaluation by analyzing topography, vegetation, and proximity to water bodies. This deep learning approach enables the system to make highly accurate predictions about how environmental factors may affect property value over time.

Additionally, the system utilizes a generative adversarial neural network (GAN) to simulate various environmental scenarios. The GAN generates synthetic data to assess how properties might respond to extreme weather events, such as flooding, hurricanes, or wildfires. By simulating these scenarios, the system can evaluate the property's resilience and adjust the property's value based on potential future risks. This feature is particularly important for assessing the long-term sustainability and risk profile of a property, giving financial institutions a clearer understanding of how environmental factors could impact loan or mortgage decisions.

To further enhance its climate analysis capabilities, the system includes a climate environment information processing module. This module integrates real-time data from environmental monitoring systems, such as IoT-connected sensors and satellite data, with historical climate records. It continuously updates the property evaluation with the latest information, ensuring that the most current environmental conditions are reflected in the assessment. The use of real-time data allows the system to dynamically adjust property valuations as new information becomes available, providing a more responsive and accurate evaluation.

The system also addresses the unique challenges of evaluating properties located in urban and rural areas. An urban/rural processing module assesses population density, economic activity, land use patterns, and infrastructure development trends to adjust the property's value based on its geographical context. This module analyzes future urbanization efforts, such as planned transportation networks or utility expansions, and incorporates these factors into the property evaluation. By understanding the specific characteristics of urban and rural environments, the system provides more tailored and accurate assessments for properties in different locations.

In addition to evaluating environmental and urban or rural factors, the system incorporates a township processing module to verify property registration records. This module retrieves property records from government databases, ensuring that the property complies with legal and regulatory standards. It also checks for potential fraud or discrepancies in the documentation. Furthermore, the township processing module utilizes blockchain-based land registry systems to ensure that all property records are tamper-proof, providing an additional layer of security to the evaluation process.

To ensure secure communication within the system, a secure messaging protocol is employed, using the MQTT protocol. This lightweight messaging protocol facilitates efficient data transfer between the bank's servers, the smart contract module, and the machine learning modules. The secure messaging protocol also incorporates quantum-resistant encryption algorithms to protect against future cryptography-breaking technologies. This guarantees that all communications within the system, particularly those involving external databases or regulatory systems, remain secure and resistant to emerging cybersecurity threats.

The system also integrates a secure access service edge (SASE) to monitor and control access to sensitive data. The SASE enforces strict permissions and uses micro-segmentation techniques to safeguard financial and property-related information. By isolating different parts of the network, the system ensures that only authorized users can access specific datasets, reducing the risk of unauthorized data breaches. This security architecture is particularly important for financial institutions, as they must handle sensitive information while maintaining compliance with data privacy regulations.

A scalable and efficient network infrastructure is critical to the system's performance, and this is achieved through the implementation of a spine-leaf network topology. This network configuration connects the various system components, including machine learning modules, smart contracts, and property databases, ensuring high-speed data transfers and minimal latency. The spine-leaf topology allows the system to scale efficiently, making it capable of handling a large volume of property evaluations simultaneously without sacrificing performance or speed.

Another significant feature of the system is its ability to handle digital end-to-end transactions. The system processes and stores all data related to property evaluations, ensuring secure handling from the initial input of data to the final loan or mortgage decision. This end-to-end transaction system provides a seamless flow of information, ensuring that the entire evaluation process is documented and stored securely. The digital transaction capabilities enhance transparency and accountability, allowing financial institutions to track the entire evaluation process for regulatory and audit purposes.

Overall, this invention offers a comprehensive solution for evaluating loans and mortgages with a high degree of precision, security, and efficiency. By leveraging advanced algorithms, machine learning, and real-time data processing, the system delivers accurate property valuations that account for a wide range of environmental and geographical factors. Its integration with external databases and regulatory systems further enhances the reliability of its evaluations, ensuring that all legal and compliance considerations are met. The security features embedded in the system, from quantum-resistant encryption to micro-segmentation, provide robust protection for sensitive financial data. The system's ability to scale, handle large datasets, and continuously update its evaluations makes it an invaluable tool for financial institutions in the modern era of climate-conscious lending and investment.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

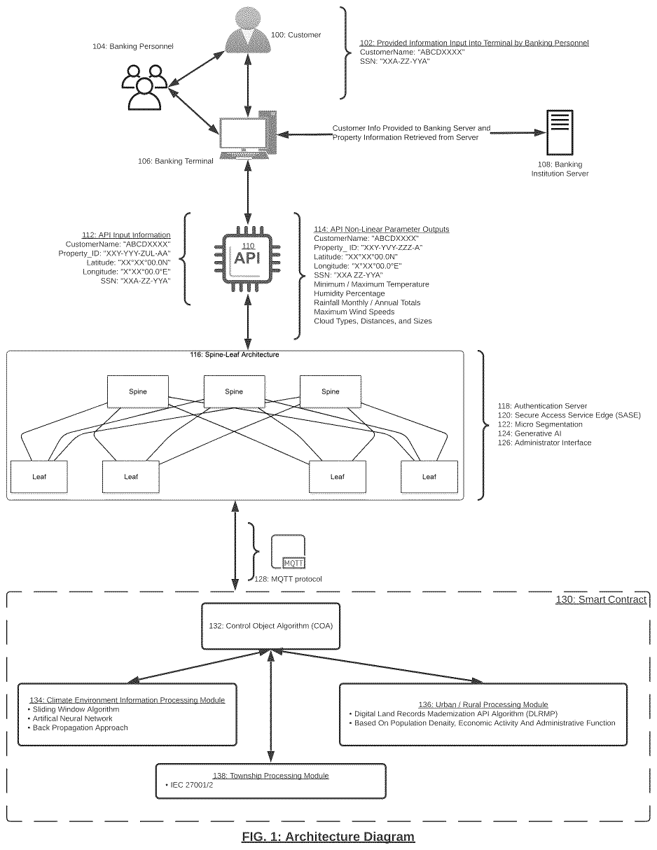

FIG. 1 presents a sample architecture of the climate-impact analytics system, which is specifically designed to provide comprehensive and accurate evaluations of loans and mortgages by incorporating environmental, geographical, financial, and legal data. The process begins with the customer 100, who interacts with a bank representative or financial personnel 104 at a banking terminal 106. The customer provides information, including personal identifiers such as their name, Social Security Number (SSN), and property-related data. This information is input into the system and then transmitted to the banking institution server 108, where it is stored, processed, and distributed to other components of the system.

The banking institution server 108 acts as a central hub, managing the data received from the customer and ensuring it is processed accurately and securely. The data is initially transmitted through an API input 112, where the system retrieves important property-specific information. This includes not only customer identifiers like SSN but also the Property_ID and geographical details such as latitude and longitude. These geographical coordinates are essential for the system to access environmental data specific to the property's location. Once this information is gathered, the API output 114 compiles an array of non-linear environmental parameters that are beneficial for a holistic evaluation. These parameters include detailed metrics such as minimum and maximum temp, humidity percentages, wind speeds, annual and monthly rainfall, and detailed cloud data, including cloud types, distances, and sizes.

The environmental data collected through API output 114 is fundamental to the system's ability to evaluate the potential risks and future conditions that may affect the property. These environmental factors can have a significant impact on property values, particularly in areas that are vulnerable to extreme weather conditions or long-term climate change effects. This enriched dataset is then transmitted to the next stages of the system for further processing, with the authentication server 118 stepping in to verify the customer's identity. This server plays a role in confirming that the customer providing the data is authorized to request a loan or mortgage evaluation, and that the data itself is accurate and legitimate.

Security is paramount throughout the entire system, and this is evident in the implementation of a secure access service edge (SASE) 120, which manages permissions and ensures that sensitive customer and property data is protected from unauthorized access. SASE works closely with micro-segmentation 122, a security architecture that isolates different areas of the network, effectively preventing unauthorized access or data leaks between unrelated sections of the system. These layers of security ensure that both customer information and property data remain protected throughout the entire evaluation process, reducing the risk of data breaches or unauthorized tampering.

The generative AI module 124 is one of the system's most advanced features, playing a pivotal role in analyzing the vast datasets collected by the system. This module utilizes machine learning techniques to identify patterns in environmental data, property trends, and market fluctuations. Over time, the AI module continuously refines its predictive models, learning from historical data to improve the accuracy of its predictions. This allows the system to provide highly precise assessments of how various factors-such as climate change, economic development, and regulatory updates—may impact the property's future value. The administrator interface 126 allows system administrators to configure and manage the generative AI module, ensuring that the machine learning models are optimized and function efficiently to meet the system's needs.

To facilitate the communication between various system components, the system uses the MQTT protocol 128, a lightweight messaging protocol that enables real-time data transfers while minimizing bandwidth usage. This protocol ensures that the large volumes of data processed by the system are transmitted quickly and securely. By leveraging MQTT, the system can handle real-time updates, environmental data feeds, and property information without delays or bottlenecks, allowing for swift and seamless processing of loan and mortgage evaluations.

Another component of the system is the smart contract module 130. This module automates many of the financial and legal processes involved in loan and mortgage evaluations, executing predefined actions based on the data provided. For example, smart contracts can automatically trigger transactions, compliance checks, and evaluations when certain conditions are met, such as verifying environmental risks or legal property documentation. This functionality is enhanced by the control object algorithm (COA) 132, which manages the flow of data between different parts of the system, ensuring that the appropriate modules receive the data they need to perform their specific tasks efficiently.

A control object algorithm is a method or mechanism used to manage and direct the flow of data or control signals between different components in a system. It ensures that each component processes the appropriate data at the right time. In complex systems, data from multiple sources must be routed through various modules or layers, each responsible for performing specific functions. The control object algorithm acts as a centralized logic system that oversees and coordinates this flow, dynamically deciding how and where to send data based on predefined rules, conditions, or the type of data.

In the context of the climate-impact analytics system, the control object algorithm is used to ensure that property and environmental data are efficiently routed to the relevant processing modules. For instance, it may decide to send urban property data to a different processing module than rural property data or direct climate risk data to a module focused on environmental analysis. By managing the flow of data, the control object algorithm optimizes the performance of the system and ensures that the correct evaluations and processes are triggered.

The control object algorithm determines which module or subsystem should process a given set of data. It takes into account the nature of the data, such as whether it is environmental, financial, or legal, and the specific requirements of the evaluation process. The algorithm adjusts the data flow dynamically based on real-time inputs and conditions. For example, if a certain risk threshold is exceeded, the algorithm might reroute the data to a module that handles higher-risk evaluations. By controlling where and how data flows, the algorithm ensures that system resources, such as processing power, memory, and bandwidth, are used efficiently. This helps prevent bottlenecks by distributing tasks across multiple components.

The control object algorithm operates across multiple independent modules or systems, each of which can function independently. This modularity allows for scalability and flexibility, as the algorithm can easily integrate new components or data sources without disrupting the overall system. In summary, a control object algorithm is essential for coordinating the flow of data in complex systems, acting as the decision-making framework necessary for the efficient and optimized operation of multi-layered data processing environments like the climate-impact analytics system.

The climate environment information processing module 134 plays a specialized role in evaluating how environmental factors affect property value. This module analyzes continuous streams of climate data, including real-time updates on temp, humidity, wind speed, and precipitation. It uses the sliding window algorithm to manage and optimize the analysis of this data, reducing the computational load while ensuring that real-time environmental conditions are considered. The artificial neural network (ANN) also contributes to this analysis, applying a backpropagation method to improve the system's predictions over time. The ANN learns from historical environmental data and refines its predictions as new data is received, ensuring that the system becomes more accurate with each evaluation.

The sliding window algorithm is a technique used to process continuous streams of data in real-time by maintaining a fixed-size subset, or “window,” of the most recent data points. As new data points are added to the window, the oldest data points are removed, ensuring that only the most relevant, up-to-date information is analyzed. This approach is particularly useful in systems that need to handle large volumes of data over time without overwhelming processing capacity, as it focuses on a limited window of data rather than attempting to analyze the entire dataset at once.

In the climate-impact analytics system, the sliding window algorithm plays an essential role in processing real-time environmental data. The system continuously collects data related to factors such as temperature, humidity, rainfall, wind speed, and other climate-related metrics that can influence property values and associated risks. Since environmental conditions can change rapidly and unpredictably, it is important for the system to analyze only the most recent data to provide accurate, real-time evaluations. The sliding window algorithm ensures that the system processes this data efficiently, without being bogged down by historical data that may no longer be relevant to the current analysis.

For example, when evaluating a property located in a coastal region, the system might need to assess the potential risk of flooding based on recent rainfall data. Using the sliding window algorithm, the system would focus on a specific timeframe-such as the past week or month—and only analyze the rainfall data within that window. As new data comes in, older data outside the window is discarded, and the new data is added to the window. This allows the system to keep track of current environmental conditions while continuously updating its analysis with the latest information.

The sliding window algorithm is particularly valuable in the climate-impact analytics system because it helps reduce computational complexity. Instead of processing an entire dataset that could span years of historical data, the system only focuses on the most recent and relevant data points. This improves the system's efficiency, ensuring that it can handle large streams of data in real-time without unnecessary delays or bottlenecks. It also ensures that the system remains responsive to immediate changes in environmental conditions, which is critical for generating accurate property evaluations.

In addition to handling real-time data, the sliding window algorithm allows the system to make more accurate predictions by ensuring that only current data is considered in the analysis. For instance, if a property is being evaluated for the risk of wildfires, the system would use the sliding window to focus on recent temperature and wind speed data, which are key indicators of wildfire risk. This helps the system provide a more accurate, up-to-date assessment of the property's risk level, allowing financial institutions to make better-informed decisions about loans and mortgages.

In summary, the sliding window algorithm is a crucial component of the climate-impact analytics system. It processes continuous streams of real-time environmental data by maintaining a window of the most recent and relevant data points. This approach reduces computational complexity, ensures timely analysis, and allows the system to provide accurate and up-to-date property evaluations based on the latest environmental conditions. By focusing on a fixed window of data, the algorithm ensures that the system remains efficient and responsive to real-time changes, making it well-suited for evaluating climate-related risks in property assessments.

An artificial neural network, or ANN, is a computational model designed to process information by mimicking how biological neural networks function in the brain. In the climate-impact analytics system, the ANN plays a critical role in analyzing complex environmental data to make predictions about property values and associated risks. The system receives vast amounts of data related to climate conditions, such as temperature, rainfall, wind speed, and other environmental factors. The ANN is responsible for identifying patterns within this data and using those patterns to predict how environmental changes might impact the long-term value of a property.

In this system, the ANN consists of interconnected layers of artificial neurons that process the input data in stages. The input layer receives the environmental data, while the hidden layers process this information through a series of mathematical transformations. Finally, the output layer generates a prediction about the property's future risk or value based on the climate data it has processed. Each connection between neurons has a weight, which determines the strength of the signal passed from one neuron to the next. These weights are critical in determining how the network interprets the data.

To improve its predictive capabilities, the ANN must learn from historical data by adjusting these weights. This learning process is accomplished through the backpropagation method, which is an essential training algorithm for ANNs. In the climate-impact analytics system, backpropagation is used to minimize errors in the network's predictions about how climate risks may affect property values. The process begins with the network making an initial prediction based on the environmental data. This prediction is then compared to the actual known outcomes or historical trends. The difference between the predicted outcome and the actual result generates an error.

Through backpropagation, this error is propagated backward through the network from the output layer to the input layer. The algorithm calculates how much each weight contributed to the overall error, allowing the system to adjust those weights accordingly. Weights that contributed more to the error are adjusted more significantly, while those that had a smaller impact on the error are changed less. This process uses a technique called gradient descent, which gradually reduces the error over time by adjusting the weights to improve the accuracy of the network's prediction.

In the context of climate-impact analytics, this learning process enables the ANN to refine its predictions over time as more data is fed into the system. For instance, if the system initially predicts that a property located near a coastline will experience moderate risk from rising sea levels, but historical data shows that sea levels are rising faster than expected, the network will adjust its weights to account for this discrepancy. Over time, the ANN becomes more accurate in predicting how various environmental factors will impact properties in different regions.

This predictive capability is crucial for financial institutions that rely on the climate-impact analytics system to assess the long-term value of properties when making decisions about loans and mortgages. By continuously learning from historical and real-time environmental data, the ANN ensures that the system provides reliable and up-to-date evaluations. The backpropagation method allows the network to self-correct, improving its performance with each iteration and making it a vital tool for understanding and predicting climate-related risks in property evaluations.

The urban/rural processing module 136 evaluates how the property's geographical location-whether urban, suburban, or rural-affects its value. This module analyzes factors such as population density, economic activity, and land use patterns, as well as future infrastructure projects like new roads, public transportation, or utilities that may impact property values in urbanizing areas. Properties in rural areas may have different economic dynamics and development prospects compared to those in urban centers, and this module ensures that such nuances are accurately reflected in the property's evaluation. This module also integrates data from the Digital Land Records Modernization Program (DLRMP), ensuring that land records are up-to-date and reflective of recent changes in property status or ownership.

The township processing module 138 ensures that all property-related legal documentation is accurate and compliant with regulatory requirements. It cross-references the property's registration records with government databases to verify ownership and identify any discrepancies or signs of fraud. This module utilizes blockchain-based land registry systems to ensure that all records are tamper-proof and transparent. By using blockchain technology, the system guarantees that property ownership is secure and that there are no ongoing title disputes or legal challenges that could affect the loan or mortgage evaluation.

The system also includes robust security protocols for data transmission. A secure messaging protocol using MQTT is employed to transfer data between the bank server, smart contract module, and other machine learning modules. This protocol ensures that all communications within the system are efficient and secure. Additionally, the system implements quantum-resistant encryption algorithms, which provide protection against future advancements in cryptography-breaking technologies. This ensures that the system remains secure as new encryption threats emerge.

Another part of the system's architecture is the spine-leaf network topology 140, which connects all the system components, including machine learning modules, smart contracts, and databases. This topology allows for scalable, high-speed data transfers between system components, minimizing latency and ensuring that even as the system scales up to handle more data and more users, it remains efficient and responsive. The spine-leaf architecture is particularly important for financial institutions that require real-time evaluations for large volumes of properties and must maintain system performance under heavy data loads.

The spine-leaf architecture is a network topology commonly used in data centers to provide fast, scalable, and efficient communication between different components of a system. It is designed to reduce latency, ensure high bandwidth, and allow the system to scale as the network grows in complexity. In a spine-leaf architecture, there are two layers: the leaf layer and the spine layer. The leaf layer consists of the switches that directly connect to servers or other computing devices, while the spine layer consists of switches that connect all the leaf switches to one another. Every leaf switch is connected to every spine switch, creating a highly redundant and fast network where data can travel efficiently between any two points without bottlenecks.

In the climate-impact analytics system, the spine-leaf architecture plays a crucial role in ensuring that data can flow smoothly between the various modules that process property, environmental, and financial information. The system involves multiple components, such as the control object algorithm, smart contracts, artificial neural networks, and environmental data processing modules. These components require real-time communication with each other to ensure that property evaluations are carried out accurately and quickly. The spine-leaf architecture enables this by providing a fast and scalable network infrastructure.

For example, when a property evaluation request is initiated, data from the customer, including property information and environmental metrics, needs to be passed between different processing modules. The spine-leaf architecture ensures that this data can move efficiently from one module to the next without delays. Because every leaf switch (which could represent a different processing module or data source) is connected to every spine switch, the network minimizes the number of “hops” data has to make between different parts of the system. This reduces latency, meaning the data moves quickly through the system, which is especially important when handling real-time environmental data or high volumes of property evaluations.

Moreover, the spine-leaf architecture is highly scalable, which is a key advantage for the climate-impact analytics system. As more properties are evaluated and more data is added to the system-whether through the addition of new environmental datasets or the scaling up of processing capacity-more leaf switches can be added to the architecture without degrading the performance of the network. This ensures that the system can handle growing demands while maintaining fast and reliable data processing.

In summary, the spine-leaf architecture ensures that the climate-impact analytics system can efficiently manage the flow of large amounts of data between its various components. It reduces network congestion, minimizes latency, and allows the system to scale smoothly as more data and modules are added. This architecture supports the high-performance requirements of the system, enabling it to deliver accurate and timely property evaluations based on real-time environmental data.

Finally, the system features a digital end-to-end transaction system that processes and stores all property-related data, ensuring that the entire evaluation process is securely documented. From the moment the customer inputs their information to the final loan or mortgage decision, every action is recorded, and all data is handled securely, protecting the integrity of the transaction. This digital transaction system improves operational efficiency, reduces the potential for human error, and ensures compliance with all legal and regulatory requirements, providing financial institutions with a reliable and secure method for evaluating loans and mortgages. The combination of real-time environmental data, secure messaging, advanced AI, and blockchain-based recordkeeping makes the system a comprehensive solution for modern financial institutions seeking to assess properties accurately and efficiently.

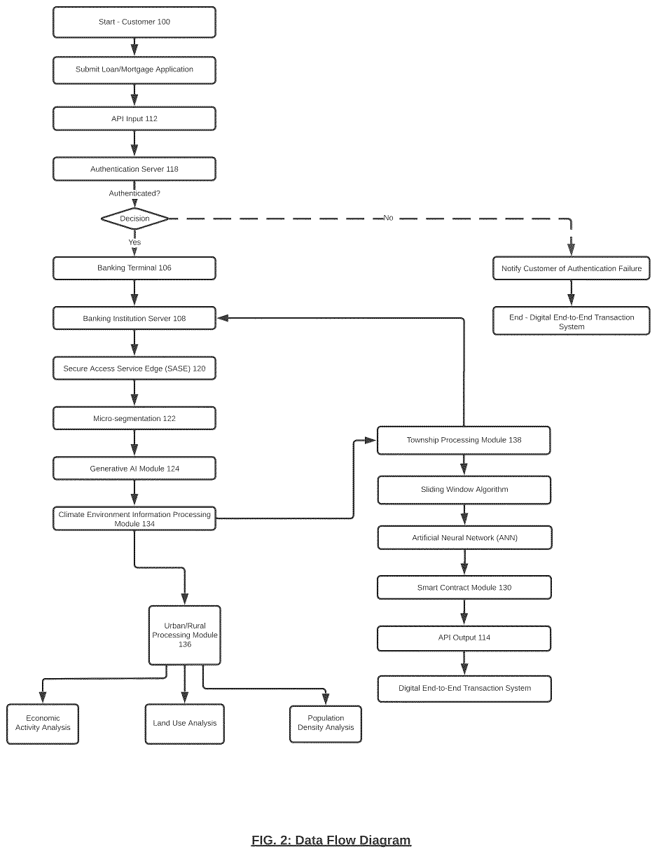

FIG. 2 depicts a detailed data flow diagram illustrating how data moves through the climate-impact analytics system during the evaluation of loans and mortgages. The process begins with the customer 100, who provides essential information such as their name, Social Security Number (SSN), and property details to the banking personnel 104 through the banking terminal 106. This information is then sent to the banking institution server 108, which acts as the central hub, receiving, storing, and managing the customer data.

Once the customer data reaches the server, it flows into the API input 112, where additional property-related information is retrieved, such as the Property_ID, latitude, and longitude of the property. The system then uses the API output 114 to pull environmental data relevant to the property's geographical location, including minimum and maximum temps, humidity percentages, wind speeds, rainfall amounts, and cloud data. These metrics are critical for evaluating how environmental factors might affect the property's future value and risk profile.

Before further processing occurs, the system verifies the customer's identity using the authentication server 118 to ensure that the data provided is legitimate. After the authentication step, the data is secured using the secure access service edge (SASE) 120, which enforces strict permissions and ensures that only authorized personnel can access sensitive customer and property data. Additionally, micro-segmentation 122 divides the network into isolated sections to protect different data types, enhancing security and preventing unauthorized access between different parts of the system.

After the data is authenticated and secured, it flows into the generative AI module 124, where advanced machine learning algorithms analyze the data for patterns and future trends. This AI module continuously improves its models by learning from both historical and real-time data, providing accurate predictions on how environmental factors or economic changes could impact the property's value over time. The system administrator has control over the AI's functionality through the administrator interface 126, which allows for monitoring and management of AI processing.

The MQTT protocol 128 facilitates communication between different modules, ensuring that data moves quickly and securely between components like the smart contract module 130, which automates the legal and financial processes involved in the evaluation. The smart contract handles actions such as compliance checks and environmental assessments based on predefined conditions, ensuring that property evaluations adhere to the necessary regulations and rules.

The data is then processed by the climate environment information processing module 134, which uses a sliding window algorithm to continuously evaluate climate-related factors like temp, humidity, wind speed, and precipitation. This ensures that real-time environmental conditions are taken into account. Additionally, an artificial neural network (ANN) is employed to improve the system's predictions by using machine learning techniques like backpropagation, making the property's evaluation more accurate with each iteration.

The system's urban/rural processing module 136 evaluates the property's location, factoring in variables like population density, land use patterns, and economic activity. This module is particularly useful in determining how urbanization or rural preservation efforts might influence the property's future value. The module also considers infrastructure developments like new roads, utilities, and public services that might affect property values in the surrounding area.

Legal verification is handled by the township processing module 138, which retrieves property registration records from government databases. This module ensures that the property complies with all legal standards and regulations while checking for any fraudulent activities or discrepancies in the property's documentation. To guarantee data integrity, the module uses blockchain technology to maintain tamper-proof property ownership records, ensuring transparency and security.

Throughout the system, data is transferred via a spine-leaf network topology 140, which connects all the system components and enables fast, reliable communication. This network topology allows the system to scale efficiently and process large amounts of data without compromising on performance or speed, ensuring that even complex evaluations are handled quickly and accurately.

Finally, all the data passes through the digital end-to-end transaction system, which securely processes and stores every step of the evaluation process. From the initial customer data input to the final loan or mortgage decision, each action is documented and secured, ensuring compliance with legal standards and reducing the possibility of errors. This end-to-end system ensures that all relevant factors are taken into account when evaluating the property, resulting in accurate and secure loan and mortgage decisions.

This data flow diagram, depicted as FIG. 2, offers a comprehensive view of how data is collected, processed, secured, and analyzed in a step-by-step manner throughout the climate-impact analytics system for evaluating loans and mortgages.

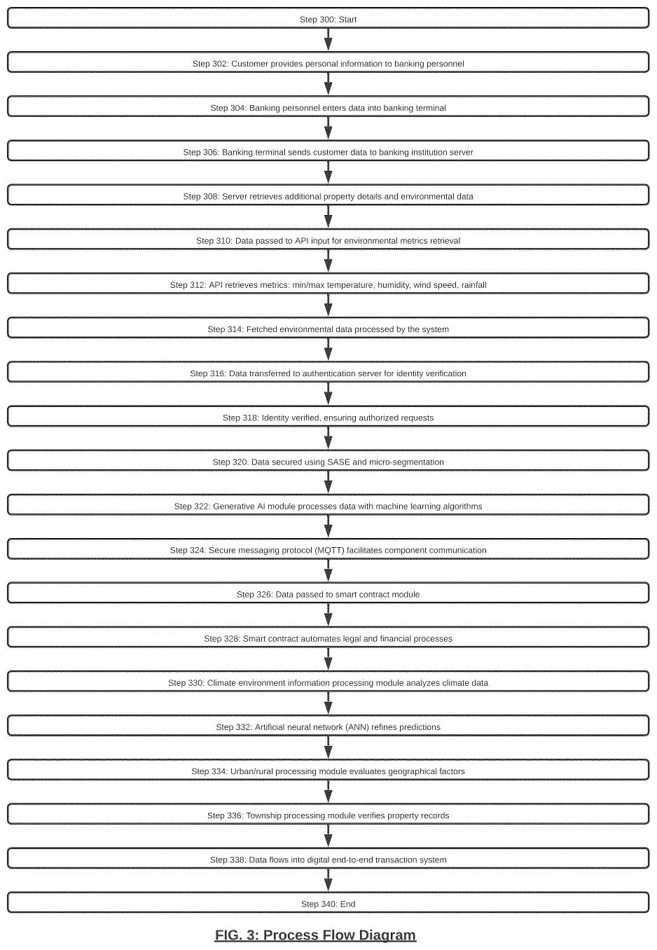

FIG. 3 illustrates a detailed process flow diagram of the climate-impact analytics system for evaluating loans and mortgages. The process begins at step 300, where the customer provides essential personal information, including their name, Social Security Number (SSN), and property-related data, to a banking personnel member. This initial data input is critical as it sets the foundation for the entire evaluation process. The customer may provide details such as the property's location, intended use, and other relevant factors. The banking personnel enters this data into the system through a banking terminal, ensuring that all necessary identifiers, including property-specific details like geographical coordinates (latitude and longitude), are recorded.

Once the data is collected at the banking terminal, it moves to step 302, where it is transmitted to the banking institution server. This server acts as the central hub that stores and manages the customer's personal and property data. In addition to handling customer-provided data, the banking institution server is responsible for interfacing with external databases to retrieve supplementary property details that may not have been initially provided. For instance, the server retrieves environmental and legal data related to the property's geographical location, including zoning regulations and environmental risk factors. This server-to-database communication is crucial for building a comprehensive dataset required for evaluating loans or mortgages.

At step 304, the data flows into the API input, where further property-related information is retrieved. The system uses specific property identifiers like the Property_ID, latitude, and longitude to gather additional environmental metrics such as minimum and maximum temps, humidity levels, rainfall patterns, wind speeds, and cloud coverage. The API output at this stage compiles these environmental metrics, which are integral to understanding the external factors that may influence the property's value and risk profile. These factors are essential when assessing the property's susceptibility to environmental changes or extreme weather events, which could significantly affect the loan or mortgage decision.

At step 306, the system processes the collected data and sends it to the authentication server at step 308. The authentication server verifies the customer's identity by cross-referencing the provided SSN and other personal details with existing records. This step ensures that the individual requesting the loan or mortgage evaluation is authorized and legitimate, preventing fraudulent activities. Authentication is critical in maintaining the integrity of the process, as it confirms the validity of both the customer's personal data and the property information they are submitting for evaluation.

Following the authentication process, the system advances to step 310, where data security is enhanced using the Secure Access Service Edge (SASE) and micro-segmentation techniques. SASE enforces strict permissions that regulate which users or modules can access specific types of data within the system. It ensures that only authorized individuals can interact with sensitive financial or property information. Simultaneously, micro-segmentation divides the network into isolated segments, preventing different areas of the network from accessing each other's data. This layered security approach minimizes the risk of unauthorized data breaches and ensures that personal, financial, and environmental data remain protected throughout the evaluation process.

At step 312, the generative AI module begins analyzing the data using advanced machine learning algorithms. This module identifies patterns and trends in the collected data, such as how environmental conditions may impact property values over time. The generative AI module continuously learns and refines its predictions by analyzing historical and real-time data. This step is critical for the system's ability to forecast the potential risks and benefits associated with a property. By identifying long-term trends-such as the effects of climate change or urban development—the AI module can provide highly accurate assessments that inform the loan or mortgage decision.

To ensure seamless communication between the various system components, step 314 involves the use of the MQTT protocol. MQTT is a lightweight messaging protocol designed to transmit data efficiently between the system's modules, including the banking institution server, smart contract module, and machine learning algorithms. This protocol ensures that data flows rapidly and securely between components, preventing bottlenecks or delays in processing. The MQTT protocol is especially valuable in maintaining the system's performance when processing large amounts of data or real-time updates from external sources.

Step 316 introduces the smart contract module, which automates many of the legal and financial processes involved in the loan or mortgage evaluation. Smart contracts are self-executing programs that enforce the rules and conditions encoded into them. In this context, the smart contract module can automatically verify compliance with regulatory requirements, perform financial calculations, and initiate actions like environmental risk assessments based on predefined criteria. This automation not only increases efficiency but also ensures that all steps adhere to legal and regulatory standards, reducing the likelihood of human error.

At step 318, the climate environment information processing module analyzes the environmental data collected earlier. This module applies a sliding window algorithm to continuously evaluate time-series data related to the property's climate, such as temp, humidity, wind patterns, and precipitation. The sliding window algorithm ensures that the system is capable of processing real-time environmental updates while reducing computational load. Simultaneously, an artificial neural network (ANN) is engaged to further analyze both historical and current environmental data. The ANN uses backpropagation to refine its predictions, improving the system's ability to accurately assess how environmental factors will impact the property's future value.

The system continues to step 320, where the urban/rural processing module evaluates the property's geographical and socio-economic context. This module factors in population density, land use, infrastructure development, and economic activity when determining the property's value. Urban properties might be affected by rapid development, while rural properties may experience different dynamics due to agricultural use or conservation efforts. Additionally, future infrastructure projects, such as transportation networks or utility expansions, can significantly affect a property's value. This module ensures that both current and future urbanization or rural preservation trends are accounted for during the evaluation.

At step 322, the township processing module is responsible for verifying the property's legal standing by accessing property registration records from government databases. This step ensures that the property complies with all legal requirements and that there are no ownership disputes or fraudulent claims associated with the property. Blockchain technology may be used within this module to maintain tamper-proof property records, further securing the data and ensuring transparency in ownership verification.

Finally, at step 324, all the data flows into the digital end-to-end transaction system. This system securely processes and stores each step of the evaluation process, from the initial data input to the final loan or mortgage decision. The end-to-end transaction system ensures that all actions are properly documented, complying with legal and regulatory standards. It also reduces the risk of human error and increases operational efficiency by automating the entire transaction process.

In summary, the process flow diagram shown in FIG. 3 provides a detailed representation of how customer and property data are handled, secured, processed, and analyzed within the climate-impact analytics system. Each step is designed to ensure accuracy, security, and compliance, ultimately leading to reliable, data-driven decisions regarding loans and mortgages. By integrating advanced technologies such as machine learning, smart contracts, and secure data protocols, the system delivers highly accurate property evaluations that account for a wide range of environmental, legal, and socio-economic factors.

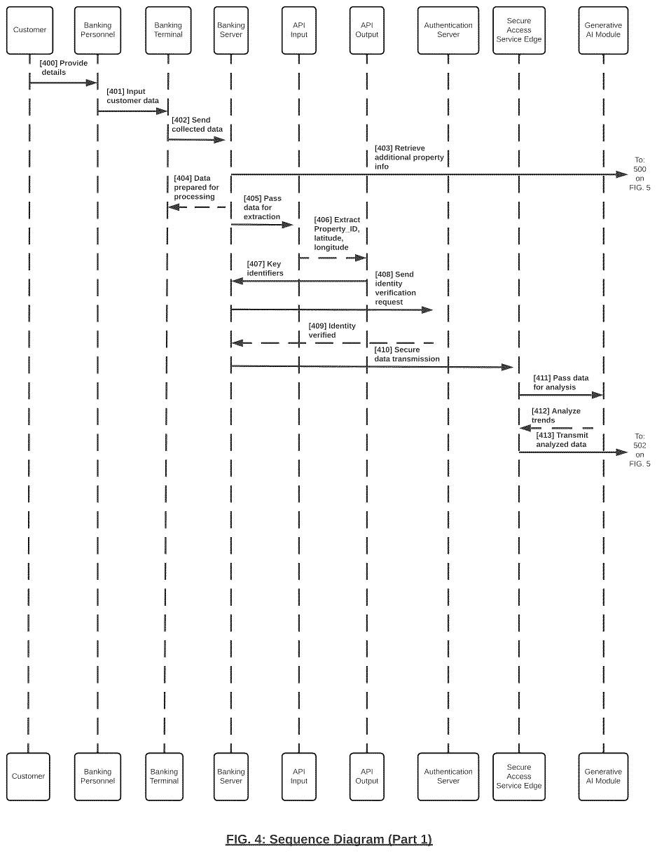

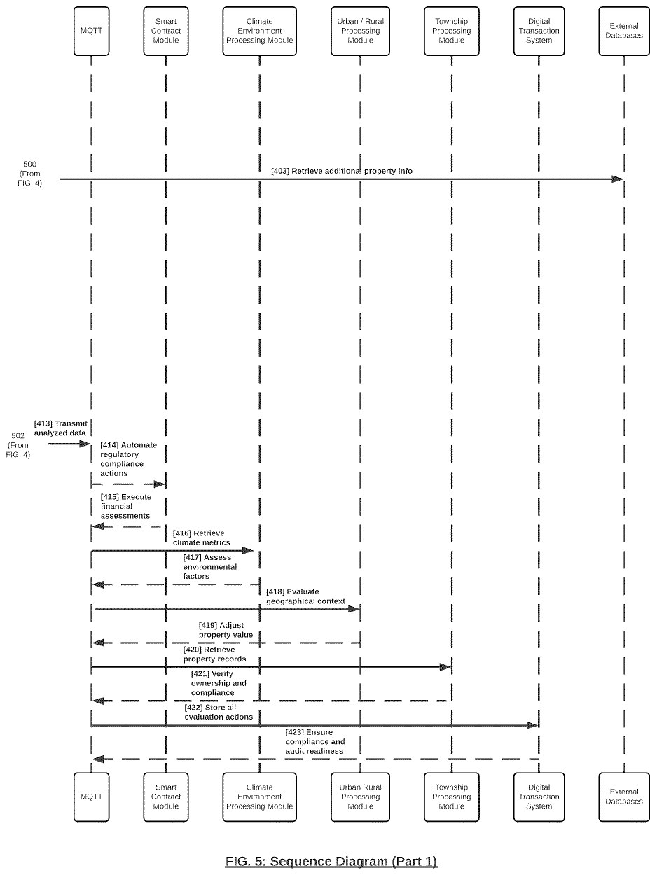

FIGS. 4 and 5 collectively depict a comprehensive sequence diagram that illustrates the interactions between various components in the climate-impact analytics system during the process of evaluating loans and mortgages. The figure provides a detailed view of how data and actions flow through the system, step by step, from initial input by the customer to the final loan or mortgage decision. Each step in the sequence is labeled, beginning at step 400 and incrementing by two for each subsequent action.

At step 400, the process starts when the customer interacts with the banking personnel to provide personal information such as their name, Social Security Number (SSN), and property details. This information is essential as it sets the foundation for the entire loan or mortgage evaluation. The banking personnel input the customer's data into the system through a banking terminal. The input data includes both personal identifiers and details about the property the customer is interested in purchasing or refinancing. This initial interaction is key, as the accuracy of the information provided at this stage will directly affect the quality of the evaluation.

In step 402, the banking terminal sends the customer's information to the banking institution server. The banking institution server serves as the central node, collecting, storing, and managing the incoming data. In addition to storing the customer's personal information, the server is responsible for retrieving further property-specific details, such as legal ownership records and environmental data, from external databases. The data retrieved by the server will be used throughout the evaluation process to provide a holistic view of the property's current condition and potential future risks.

At step 404, the banking institution server passes the data to the API input module. The API input is responsible for extracting and preparing specific identifiers, including the Property_ID, latitude, and longitude of the property. These geographical coordinates are crucial, as they enable the system to gather location-based environmental data relevant to the property. The accurate extraction and handling of this data ensure that the subsequent analysis can consider the exact environmental factors that apply to the property's location.

Step 406 involves the API output, where the system retrieves critical environmental metrics associated with the property's location. These metrics include important details such as temp extremes (both minimum and maximum), humidity levels, annual rainfall, wind speeds, and even data about cloud cover. This environmental data forms a key part of the property's evaluation, as it allows the system to assess the potential risks associated with climate conditions, natural disasters, and long-term environmental changes.

Once the environmental data is collected, the system moves to step 408, where the authentication server verifies the customer's identity. This step is crucial in preventing fraudulent activity and ensuring that only authorized individuals can proceed with the evaluation. The authentication server cross-references the customer's provided SSN and other personal information with existing databases to confirm their legitimacy. Successfully passing this authentication step allows the system to proceed with confidence that the correct individual is requesting the evaluation.

At step 410, following successful authentication, the system secures the data using the secure access service edge (SASE). SASE ensures that only authorized users have access to sensitive data by enforcing strict network permissions. This is further bolstered by micro-segmentation, which takes place simultaneously, isolating different sections of the network. Micro-segmentation ensures that data from different parts of the system remains separate, preventing unauthorized access between unrelated sections. This layered security approach guarantees that both personal and property-related data is protected throughout the evaluation process.

In step 412, the generative AI module begins its analysis. This AI module applies machine learning techniques to analyze the data gathered thus far, identifying patterns and trends that may influence the property's value. For example, the AI may detect historical climate patterns or property value fluctuations related to environmental conditions. As the AI processes this data, it continuously learns and improves its predictive models, ensuring that future property evaluations become more accurate over time. This machine learning-based approach is essential for the system's ability to forecast potential risks and benefits associated with the property.

Step 414 involves the MQTT protocol, which is used to facilitate communication between the various components of the system. MQTT is a lightweight messaging protocol designed for efficient data transfer between the server, the AI module, and other processing units. The protocol ensures that data moves quickly and securely between components, without creating bottlenecks or delays. This real-time communication is essential for ensuring that each step in the evaluation process happens seamlessly and efficiently.

At step 416, the smart contract module takes over. Smart contracts are self-executing pieces of code that automate many legal and financial processes. In this system, the smart contract module is responsible for verifying compliance with regulatory standards and automating tasks related to the property evaluation. These tasks could include performing automated financial assessments, calculating risks, or validating property ownership. Smart contracts ensure that each action follows predefined rules and conditions, reducing the need for manual intervention and increasing the overall speed and reliability of the evaluation process.

In step 418, the climate environment information processing module receives the environmental data collected earlier and begins analyzing it using a sliding window algorithm. This algorithm allows the system to continuously process time-series environmental data, such as real-time temp and humidity measurements. At the same time, the artificial neural network (ANN) is also engaged, applying backpropagation to refine its predictive models. The ANN processes both historical and current environmental data to make more accurate predictions about the property's susceptibility to environmental risks, such as flooding, extreme weather, or climate change. Together, the sliding window algorithm and the ANN ensure that the property evaluation reflects the most up-to-date environmental conditions.

In step 420, the urban/rural processing module evaluates the property's geographical context. This module takes into account various socio-economic factors, such as population density, land use patterns, and infrastructure development. Properties in urban areas may benefit from future infrastructure projects like new roads or public transportation, which can increase their value over time. Conversely, rural properties may have different dynamics, such as agricultural use or land preservation efforts. The module adjusts the property's value based on these factors, ensuring that both current and future trends are considered in the evaluation.

At step 422, the township processing module retrieves property registration records from government databases and blockchain-based land registry systems. This step ensures that the property complies with all legal requirements and verifies the validity of the property's ownership. The module checks for any discrepancies or fraudulent claims related to the property's history, and by using blockchain technology, it guarantees that the property records are tamper-proof and secure.

Finally, in step 424, the data flows into the digital end-to-end transaction system. This system securely processes and stores each step of the evaluation, from the initial customer data input to the final loan or mortgage decision. The end-to-end transaction system ensures that all actions are properly documented, complying with legal and regulatory standards. By automating the entire process and securing each step, the system reduces the potential for human error and ensures that the evaluation process is transparent and trustworthy.

Thus, the sequence diagram, provides a detailed and structured representation of how the climate-impact analytics system handles the evaluation of loans and mortgages. The diagram clearly outlines how data flows from one component to the next, with each interaction between system elements depicted in a logical and sequential manner. The sequence begins with customer input and continues through a series of automated and secure steps, ultimately leading to an accurate and reliable loan or mortgage decision that takes into account a wide range of environmental, legal, and financial factors.

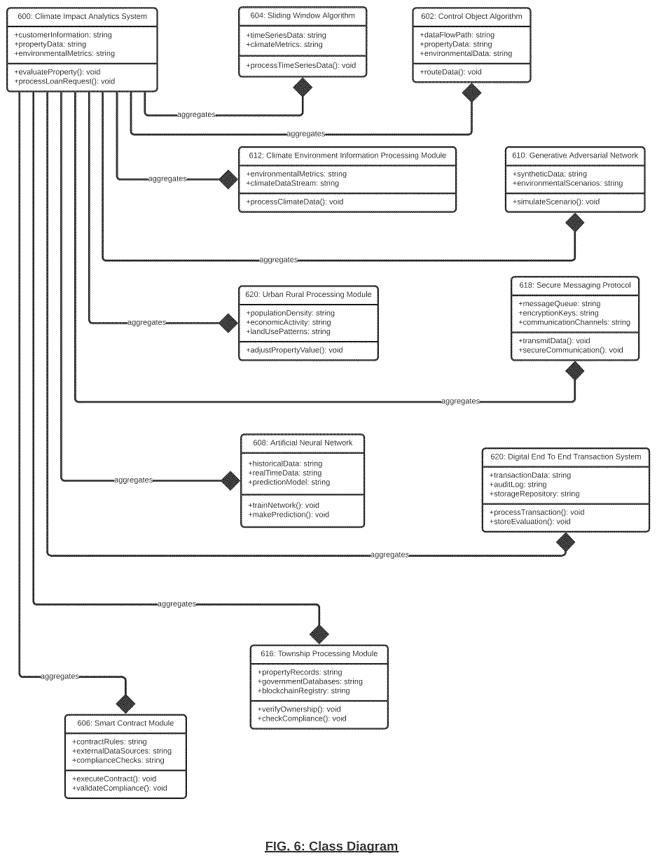

FIG. 6 depicts the interaction between various components of the climate-impact analytics system, highlighting the communication flow between smart contracts, machine learning algorithms, and environmental data processing modules. The figure emphasizes how the smart contract module interacts with the artificial neural network (ANN) and sliding window algorithm to automate decision-making based on real-time environmental data, while ensuring secure data transmission and compliance with legal standards.

Class 600 represents the climate-impact analytics system as a whole, encompassing all other components and modules responsible for the evaluation process. The primary attributes of this class include customerData, propertyData, and environmentalMetrics, which store the essential information needed for property evaluation. The methods include evaluateProperty( ) and processLoanRequest( ), which are the key functions triggered when the system receives a request to evaluate a loan or mortgage. This class manages the overall workflow of data collection, processing, and decision-making based on the inputs from the customer and the modules within the system.

Class 602 represents the control object algorithm (COA), which is responsible for managing the data flow between different components of the system. This algorithm ensures that data is routed to the correct processing modules depending on the type of property being evaluated and the type of data collected. The class has attributes such as dataFlowPath, propertyData, and environmentalData. The routeData( ) method dynamically determines how and where data should be sent within the system, optimizing the flow of information to the relevant modules, ensuring that the evaluation process is efficient and accurate.

Class 604 is the sliding window algorithm, designed to process continuous streams of time-series data, such as temp, humidity, rainfall, and wind speed. The attributes of this class include timeSeriesData and climateMetrics, which hold the incoming environmental data that needs to be analyzed. The primary method of this class is processTimeSeriesData( ), which processes the environmental data in real-time, reducing computational complexity while ensuring that the system can handle large volumes of data without delays. The sliding window algorithm helps the system keep track of changing environmental conditions as they occur.

Class 606 is the smart contract module, which automates secure data exchange and legal processes between the banking system and external data sources, such as government databases and regulatory bodies. The attributes include contractRules, externalDataSources, and complianceChecks, which store the contract terms, the data sources for verification, and the compliance requirements, respectively. The main methods include executeContract( ), which triggers predefined actions such as data retrieval or validation, and validateCompliance( ), which ensures that all data involved in the property evaluation follows legal and regulatory guidelines. This class automates many of the financial and legal steps in the evaluation process, reducing manual labor and ensuring adherence to rules.

Class 608 represents the artificial neural network (ANN), responsible for analyzing historical and real-time environmental data to predict trends affecting property values. The ANN learns from past data and makes predictions about future property risks. The attributes include historicalData, realTimeData, and predictionModel, which hold the data used to train the network and the models used to generate predictions. The methods trainNetwork( ) and makePrediction( ) are used to refine the ANN's ability to predict property value fluctuations based on environmental conditions, allowing for more accurate assessments as the network learns from new data.

Class 610 is the generative adversarial network (GAN), which simulates different environmental scenarios to assess the resilience of a property. This class includes attributes such as syntheticData and environmentalScenarios, which store the artificially generated data used in the simulations. The primary method is simulateScenario( ), which generates extreme weather or environmental events (such as floods, hurricanes, or droughts) and evaluates how the property might respond to such risks. The GAN's role is to test various scenarios that are difficult to predict using traditional data and provide insights into potential future risks.

Class 612 represents the climate environment information processing module, which integrates and analyzes climate data using the sliding window algorithm. The attributes for this class include environmentalMetrics, which hold the continuous stream of environmental data, and climateDataStream, which represents the real-time climate information that the system processes. The method processClimateData( ) is responsible for applying the sliding window algorithm to manage and analyze climate data efficiently, ensuring that the most recent and relevant information is used in the property evaluation.

Class 614 is the urban/rural processing module, which adjusts property evaluations based on geographical context. Attributes such as populationDensity, economicActivity, and landUsePatterns help the system understand the area surrounding the property. The method adjustPropertyValue( ) modifies the property's evaluation based on whether it is located in an urban or rural environment, factoring in key variables such as future infrastructure developments, zoning laws, and demographic changes. For example, properties in urban areas may have higher future value potential due to planned development, while rural properties may be influenced by agricultural activity or conservation efforts.

Class 616 is the township processing module, which is tasked with verifying the legal status of the property by retrieving property records from government databases. The attributes include propertyRecords, governmentDatabases, and blockchainRegistry. The blockchain registry ensures that all data retrieved is tamper-proof, providing an immutable record of ownership. The primary methods are verifyOwnership( ) and checkCompliance( ), which confirm that the property's ownership is valid and that there are no outstanding legal disputes or compliance issues. This module ensures that any property evaluated for a loan or mortgage is free from legal entanglements.

Class 618 represents the secure messaging protocol (MQTT), responsible for facilitating data exchange between the various components of the system, such as the banking institution server, smart contract module, and AI processing units. Attributes such as messageQueue, encryptionKeys, and communicationChannels ensure that data is securely transmitted between components. The methods transmitData( ) and secureCommunication( ) handle the process of transmitting data efficiently and securely, ensuring that the system operates smoothly and without unauthorized access.

Class 620 is the digital end-to-end transaction system, which securely handles and stores all data related to property evaluations. This class ensures that the entire process, from the initial customer input to the final decision, is documented and stored for future reference. The attributes include transactionData, auditLog, and storageRepository, which store the information about each transaction, maintain a log of all actions taken during the evaluation process, and ensure secure long-term storage. The methods processTransaction( ) and storeEvaluation( ) handle the secure processing of data and the long-term retention of property evaluations for audit and compliance purposes.

In summary, the class diagram with classes numbered from 600 to 620 provides a detailed breakdown of the major components of the climate-impact analytics system described in claims 1-11. Each class plays a distinct role in processing, analyzing, securing, and storing data related to property evaluations. These components work together to automate the evaluation process, ensuring accuracy, compliance, and security throughout each step of the system. Each module is designed to handle specific aspects of the evaluation, from climate data processing to legal verification and secure communication, making the system robust and efficient.

Pseudocode exemplars for implementing various aspects of this disclosure are set forth below with explanations for reference.

To implement the various aspects of the climate-impact analytics system for evaluating loans and mortgages, the pseudocode can be broken down into several interconnected components. These include functions for data flow management, real-time environmental data processing, property evaluation, smart contract execution, and secure communication. The pseudocode will outline how each part of the system operates in unison, following the structure presented in the class diagram. Below is a detailed explanation of how the pseudocode would be structured and implemented.

First, we define the overarching climate-impact analytics system, which handles the entire workflow from customer data input to the final decision. The system's main function, ‘evaluateProperty( )’, accepts customer data and property details as input and coordinates the various components to generate a loan or mortgage evaluation. The system retrieves customer and property information and triggers the data flow management process via the control object algorithm.

```
function evaluateProperty(customerData, propertyData)
  propertyID = retrievePropertyID(propertyData)
  environmentalData = APIInput(propertyID)
  authenticated = authenticationServer(customerData)
  if authenticated:
    secureAccess( )
    COA = ControlObjectAlgorithm(propertyData, environmentalData)
    COA.routeData( )
    evaluation = SmartContractModule(contractRules,
    environmentalData,
propertyData)
    climateData =
    ClimateEnvironmentInfoProcessing(environmentalData)
    ANN = ArtificialNeuralNetwork(climateData)
    ANN.trainNetwork( )
    prediction = ANN.makePrediction( )
    finalEvaluation = SmartContractModule.executeContract(prediction)
    return finalEvaluation
  else:
    return “Authentication Failed”
end function
```

This pseudocode begins by retrieving property and environmental data. The ‘APllnput( )’ function collects environmental metrics such as temp, rainfall, and wind speed by accessing external databases. Once data is gathered, the system invokes the ‘authenticationServer( )’ function to verify the customer's identity. If the customer is authenticated, the secure access service edge (SASE) is invoked to ensure that data access permissions are enforced.

Next, the control object algorithm (COA) is triggered by the ‘routeData( )’ function. This function determines how to route the customer's property and environmental data to the appropriate processing modules. It ensures that real-time environmental data is routed to the sliding window algorithm for continuous processing.

The system proceeds by invoking the smart contract module to automate various legal and financial processes related to the evaluation. The ‘SmartContractModule( )’ function accepts contract rules, environmental data, and property data, and validates these inputs against predefined conditions such as regulatory standards and compliance checks. Meanwhile, the ‘ClimateEnvironmentlnfoProcessing( )’ function handles real-time environmental data, processing it through the sliding window algorithm to ensure the data remains up-to-date.

The artificial neural network (ANN) is responsible for analyzing historical and real-time environmental data. The ANN first trains itself using the ‘trainNetwork( )’ function, which processes historical data and refines its prediction models. Once trained, the ANN makes property-related predictions using the ‘makePrediction( )’ function, which evaluates long-term risks associated with the property, such as environmental damage, climate risks, or natural disasters. The final evaluation is generated by the smart contract, which executes the contract using the ‘executeContract( )’ function.

The control object algorithm plays an important role in managing data flow throughout the system. Its pseudocode is designed to handle the routing of property and environmental data to specific modules:

```
function ControlObjectAlgorithm(propertyData, environmentalData)
  routeData( )
  if propertyData.type == “Urban”:
    call UrbanProcessingModule(propertyData)
  else if propertyData.type == “Rural”:
    call RuralProcessingModule(propertyData)
  end if
  if environmentalData.hasClimateRisk( ):
    call ClimateEnvironmentInfoProcessing(environmentalData)
  end if
end function
```

This function checks the type of property, either urban or rural, and routes the data to the appropriate processing module. For urban properties, it invokes the urban processing module, and for rural properties, it calls the rural processing module. Additionally, the COA checks the environmental data for climate risks, such as floods, droughts, or extreme temps. If such risks are identified, the system passes the data to the climate environment information processing module for further evaluation.

The sliding window algorithm, responsible for processing real-time environmental data, is essential for ensuring that the most up-to-date information is used in property evaluations. The pseudocode for the sliding window algorithm is:

```
function processTimeSeriesData(climateDataStream)
  window = [ ]
  for each dataPoint in climateDataStream:
    window.append(dataPoint)
    if len(window) > WINDOW_SIZE:
      window.pop(0) // maintain sliding window
    processWindowData(window)
  end for
end function
```

The sliding window algorithm maintains a list (window) of the most recent environmental data points. Each time new climate data is received, it is added to the window, and the oldest data is removed once the window reaches a predefined size. This ensures that only the most relevant and recent data is processed by the system, making the evaluation more accurate in reflecting real-time conditions.

The artificial neural network (ANN) pseudocode involves both training the network and making predictions based on processed environmental data:

```
function trainNetwork(historicalData)
  for each dataPoint in historicalData:
    updateWeights(dataPoint)
  end for
end function
function makePrediction(climateData)
  inputLayer = formatInput(climateData)
  output = forwardPropagate(inputLayer)
  return output
end function
```

The ANN trains itself by adjusting its internal weights based on historical data points, improving its ability to recognize patterns and predict outcomes. Once trained, the ‘makePrediction( )’ function formats the climate data and uses forward propagation to generate a prediction about the property's future risk or value, which is passed to the smart contract module for decision-making.

The smart contract module automates key aspects of the evaluation, using the following pseudocode:

```
function executeContract(prediction)
  if prediction.meetsThreshold( ):
    approveLoan( )
  else:
    rejectLoan( )
  end if
end function
```

This function compares the ANN's prediction to predefined contract rules and conditions. If the prediction meets certain thresholds-such as low climate risk or strong property value—the smart contract approves the loan. Otherwise, it rejects the loan application, ensuring that all decisions are automated and adhere to regulatory and financial standards.

Finally, the secure messaging protocol (MQTT) is responsible for ensuring that data is transmitted securely across the system:

```
function transmitData(message)
  encryptedMessage = encrypt(message, encryptionKeys)
  sendToNetwork(encryptedMessage)
end function
function secureCommunication(messageQueue)
  while not messageQueue.empty( ):
    message = messageQueue.pop( )
    transmitData(message)
  end while
end function
```

The ‘transmitData( )’ function encrypts data before sending it across the network, ensuring that all communications are secure. The secure communication protocol retrieves messages from the queue and processes them in real-time, ensuring that no data is lost or compromised during transmission.

In summary, the pseudocode represents how the climate-impact analytics system operates by coordinating multiple algorithms and modules to evaluate loans and mortgages. It describes how data is collected, authenticated, processed, routed, analyzed, and communicated through the system, ensuring that property evaluations are based on the most current environmental and legal information. This approach leverages machine learning models, smart contracts, and secure communication protocols to deliver accurate, reliable, and automated evaluations.

Upon reviewing the disclosure of the climate-impact analytics system for evaluating loans and mortgages, a skilled artisan would appreciate that there are numerous alternatives, modifications, combinations, and customizations that could be made to the systems and methods described. These variations may arise from the evolving needs of different financial institutions, technological advancements, or specific market requirements. Below is a detailed explanation of how a skilled artisan might implement these alternatives, modifications, combinations, and customizations, followed by a comprehensive list. All are within the spirit and scope of the disclosed inventions.

A skilled artisan would recognize that the core structure of the system-comprising data input, environmental analysis, machine learning models, smart contract automation, and secure communication protocols—can be adjusted based on the type of data, the specific property characteristics, or the institution's regulatory requirements. For example, while the system is described for evaluating loans and mortgages based on environmental risks and legal compliance, a skilled artisan might adapt the system to handle different kinds of financial transactions, such as insurance underwriting, real estate investment decisions, or risk assessment for infrastructure projects. The flexibility of the control object algorithm (COA) and smart contract modules allows for seamless integration into various financial services industries.

### Sample Alternatives:

a. Alternative Data Sources: The system can incorporate different types of environmental data sources beyond what is described. For instance, satellite imagery, drone-based data collection, or sensor networks could be used to enhance the climate and environmental risk assessments.
b. Alternative Machine Learning Models: Instead of using a traditional artificial neural network (ANN), the system could use alternative models such as decision trees, support vector machines, or gradient boosting algorithms, depending on the specific evaluation needs and computational resources.
c. Alternative Smart Contract Frameworks: While smart contracts are described in the system using predefined rules, the system could employ more advanced blockchain platforms that allow for decentralized and immutable transactions, such as Ethereum, Polkadot, or Hyperledger.
d. Geographical Expansion: The system can be extended to evaluate properties in regions outside the initial design scope by integrating region-specific regulatory databases, climate datasets, and geographical risk factors.
e. Alternative Security Protocols: The MQTT protocol could be replaced with more advanced or institution-specific secure communication protocols such as Zero Trust Architecture (ZTA), TLS/SSL-based systems, or quantum encryption techniques for enhanced security.

### Sample Modifications:

a. Adjustments to Sliding Window Algorithm: The sliding window algorithm could be modified to use variable-sized windows that adjust dynamically based on the data volume, property type, or specific time period being analyzed. The system might also introduce weighted windows to emphasize recent data over older data.
b. Modification to COA for Custom Data Routing: The control object algorithm could be modified to handle custom routing logic based on new property classes such as coastal properties, historical buildings, or properties located in special economic zones. It could also include additional decision-making criteria for routing based on risk profiles.
c. Modifications to Smart Contracts: The smart contract module could be expanded to support multi-party contracts, enabling interactions between multiple stakeholders, including governments, insurers, and buyers. The contract conditions could also be tailored for specific regulatory environments, such as those requiring more rigorous compliance checks in certain regions.
d. Custom Thresholds for Environmental Risk Assessment: The thresholds used for evaluating climate risks could be customized based on evolving industry standards, client preferences, or updated climate models, allowing for more or less conservative evaluations based on the specific risk tolerance of the financial institution.
e. Data Aggregation Modifications: The data collection process could be modified to aggregate data from multiple sources at once, combining real-time data feeds from local weather stations, climate models, and environmental agencies to provide more granular and accurate predictions.

### Sample Combinations:

a. Combination of ANN with GAN: The system could combine the artificial neural network (ANN) and the generative adversarial network (GAN) into a hybrid model that improves predictive accuracy by training the ANN with synthetic data generated by the GAN. This would be especially useful in simulating rare or extreme environmental events, which may not be present in historical datasets.
b. Integration with External Financial Systems: The climate-impact analytics system could be combined with third-party financial systems, such as mortgage platforms, insurance systems, or investment platforms, to provide a holistic view of property-related financial risk. For example, real estate portfolio managers could integrate the system to evaluate long-term environmental impacts across multiple properties.
c. Use of Multiple Blockchain Systems: The system could combine multiple blockchain platforms to handle different aspects of the process, such as using one blockchain for smart contract execution and another for property title verification. This approach would provide more flexibility and could align with specific regulatory or operational needs.
d. Combination of Environmental Data and Socioeconomic Data: The system could integrate socioeconomic data (such as employment rates, income levels, or local economic activity) alongside environmental data to generate a more comprehensive evaluation. This would allow the system to consider both climate risks and regional economic health in its property evaluations.
e. Cross-institutional Collaboration: The system could combine data from multiple institutions, such as banks, insurers, and environmental agencies, to create a shared platform that offers real-time updates on property risk. This could enable collective decision-making, for example, when evaluating loans in disaster-prone areas.

### Sample Customizations:

a. User-defined Evaluation Criteria: Financial institutions could customize the evaluation process by allowing users to define their own criteria for risk tolerance, thresholds for environmental risks, or specific factors to emphasize in the evaluation. This would enable tailored assessments for each client or property.
b. Customizable Reporting Templates: The system could be customized to generate reports in different formats or layouts, depending on the preferences of the institution or regulatory requirements. This includes adding or removing specific data points or sections, such as focusing more on compliance, climate risk, or financial viability.
c. Language and Regional Customizations: The system could be localized for use in different countries or regions by customizing language, currency, and regulatory databases. For example, it could integrate regional climate data specific to Southeast Asia or legal compliance for property titles in Europe.
d. Custom AI Models for Specific Property Types: The AI models could be customized to handle unique property types, such as commercial real estate, industrial zones, or agricultural land, by training specialized models that focus on the distinct characteristics and risks of these property types.
e. Custom Environmental Metrics: Institutions could customize which environmental factors they want to prioritize, such as focusing more on water scarcity for properties in arid regions, or storm surges for coastal properties. This flexibility allows the system to adapt to different regional risks and customer needs.

Thus, a skilled artisan would understand that the described system is highly adaptable and can be tailored to meet various institutional requirements and technological advancements. Each module can be enhanced, integrated, or modified to provide a more efficient, secure, or specialized solution based on the specific use case or regional need.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A climate-impact analytics system for evaluating loans and mortgages, comprising:
a control object algorithm configured to manage data flow between various system components, the control object algorithm routing property data and environmental data to appropriate processing modules for analysis by dynamically adjusting routing based on property type to engage specialized modules, thereby improving evaluation efficiency for residential, commercial, industrial, or agricultural properties;
a sliding window algorithm configured to process continuous streams of time-series data, including temp, humidity, rainfall, and wind speed data, the sliding window algorithm reducing computational complexity by optimizing data analysis through transformation of nested loops into a single loop for real-time handling of seasonal variations and prediction of environmental impacts on property values;
a smart contract module configured to automate secure data exchange between financial institution systems and external data sources, the smart contract module facilitating real-time data processing and decision-making for property evaluations by integrating with regulatory databases to verify compliance with environmental laws in real-time, ensuring legal restrictions are reflected without manual intervention;
an artificial neural network configured to analyze and predict trends based on historical and real-time environmental data, the artificial neural network applying a backpropagation approach to improve accuracy of property evaluations over time using a multi-layered architecture with convolutional layers to process geospatial imagery and analyze land features such as topography, vegetation, and proximity to water bodies for enhanced contextual evaluation;
a generative adversarial neural network configured to simulate network configurations and optimize system performance, the generative adversarial neural network ensuring secure and resilient data transmission throughout the system by generating synthetic environmental scenarios, such as extreme weather events, to assess property resilience and adjust evaluations based on potential future environmental risks, wherein the generative adversarial neural network generates artificial scenarios to test the system's network defenses;
a climate environment information processing module configured to integrate and analyze environmental factors, the climate environment information processing module applying the sliding window algorithm to handle continuous climate data streams and generate a comprehensive evaluation of property environmental conditions with real-time updates from monitoring systems for continuous value reassessment, wherein said real-time data allows the system to dynamically adjust property valuations as new information becomes available;
an urban/rural processing module configured to assess population density, economic activity, and land use patterns for properties, the urban/rural processing module adjusting the property evaluation based on urbanization or rurality factors by analyzing infrastructure trends to predict future value changes;
a township processing module configured to retrieve and verify property registration records from government databases, the township processing module ensuring compliance with legal and regulatory standards, and identifying potential fraud or documentation discrepancies using blockchain-based systems for tamper-proof verification of boundaries and ownership history;
a secure messaging protocol, using a MQTT protocol, configured to transmit data between a bank server, the smart contract module, and machine learning modules, the secure messaging protocol ensuring secure and efficient communication during a property evaluation process with quantum-resistant encryption to protect against cryptography-breaking threats;
a secure access service edge (SASE) configured to monitor and control access to the system, the secure access service edge enforcing permissions and utilizing micro-segmentation techniques to protect sensitive financial and property-related data;
a spine-leaf network topology configured to connect the system components, including machine learning modules, smart contracts, and property databases, the spine-leaf network topology providing scalable, high-speed data transfers and minimizing latency during the property evaluation process to enable real-time processing of large climate datasets without bottlenecks, wherein said spine-leaf network topology provides high-speed data transfers and minimizes latency, enabling the climate-impact analytics system to process multiple property evaluations simultaneously; and
a digital end-to-end transaction system configured to process and store all data related to property evaluations, the digital transaction system ensuring secure handling of property evaluation data from initial input to final loan or mortgage decision by automating resilient transactions that adapt to environmental risk assessments.

2. The system of claim 1, wherein the control object algorithm is further configured to dynamically adjust the routing of data based on a type of property being evaluated, including residential, commercial, industrial, or agricultural properties, ensuring that the appropriate modules are engaged for specialized evaluation.

3. The system of claim 2, wherein the sliding window algorithm is further configured to incorporate seasonal variations in climate data, allowing for more accurate predictions of environmental impact on property values during different times of a year.

4. The system of claim 3, wherein the smart contract module is further configured to integrate with external regulatory databases to automatically retrieve and verify compliance with environmental laws and building codes, ensuring that property evaluations reflect any legal restrictions or considerations.

5. The system of claim 4, wherein the artificial neural network is further configured to utilize a multi-layered architecture that includes convolutional layers to process geospatial imagery of the property, providing additional context to the evaluation by analyzing land features such as topography, vegetation, and proximity to water bodies.

6. The system of claim 5, wherein the generative adversarial neural network is further configured to generate synthetic environmental scenarios, such as extreme weather events, to assess property resilience and adjust the evaluation based on potential future environmental risks.

7. The system of claim 6, wherein the climate environment information processing module is further configured to receive real-time updates from environmental monitoring systems, allowing for continuous reassessment of the property's value based on the latest climate data.

8. The system of claim 7, wherein the urban/rural processing module is further configured to assess infrastructure development trends in a surrounding area, including transportation networks, utilities, and commercial developments, and adjust the property's evaluation based on potential future urbanization or rural preservation efforts.

9. The system of claim 8, wherein the township processing module is further configured to verify property boundaries and ownership history using blockchain-based land registry systems, ensuring that all property records are tamper-proof and that any title disputes are accounted for in the evaluation.

10. The system of claim 9, wherein the secure messaging protocol is further configured to utilize quantum-resistant encryption algorithms, ensuring that all communications within the system, including those involving external databases and regulatory systems, remain secure against future advancements in cryptography-breaking technologies.

11. A climate-impact analytics system for evaluating loans and mortgages, comprising:
a control object algorithm configured to manage data flow between various system components, the control object algorithm dynamically adjusting a routing of data based on a type of property being evaluated, including residential, commercial, industrial, or agricultural properties, and routing property data and environmental data to appropriate processing modules for analysis to improve data processing efficiency and enable specialized risk assessments;
a sliding window algorithm configured to process continuous streams of time-series data, including temp, humidity, rainfall, and wind speed data, the sliding window algorithm reducing computational complexity by optimizing data analysis, and further incorporating seasonal variations in climate data to predict the impact of environmental conditions on property values at different times of a year through transformation of nested loops into a single loop, thereby enabling real-time handling of large-scale climate datasets without computational bottlenecks;
a smart contract module configured to automate secure data exchange between financial institution systems and external data sources, the smart contract module integrating with external regulatory databases to automatically retrieve and verify compliance with environmental laws and building codes, and facilitating real-time data processing and decision-making for property evaluations to ensure automated compliance verification and reduce manual errors in regulatory assessments;
an artificial neural network configured to analyze and predict trends based on historical and real-time environmental data, the artificial neural network applying a backpropagation approach to improve accuracy of property evaluations over time, and utilizing a multi-layered architecture with convolutional layers to process geospatial imagery, thereby analyzing land features such as topography, vegetation, and proximity to water bodies for granular, context-aware risk profiling that enhances predictive accuracy;
Sa generative adversarial neural network configured to simulate network configurations and optimize system performance, the generative adversarial neural network further generating synthetic environmental scenarios, such as extreme weather events, to assess property resilience and adjust the evaluation based on potential future environmental risks, and ensuring secure and resilient data transmission throughout the system by testing and reinforcing network defenses against data breaches in high-stakes financial evaluations, wherein the generative adversarial neural network generates artificial scenarios to test the climate-impact analytics system's defenses;
a climate environment information processing module configured to integrate and analyze environmental factors, the climate environment information processing module applying the sliding window algorithm to handle continuous climate data streams and generate a comprehensive evaluation of property environmental conditions, and further receiving real-time updates from environmental monitoring systems to allow continuous reassessment of the property's value, thereby addressing catastrophic forgetting in continual learning and providing adaptive, resilient property valuations, wherein said real-time updates enables the climate-impact analytics system to dynamically adjust property valuations as new information becomes available;
an urban/rural processing module configured to assess population density, economic activity, and land use patterns for properties, the urban/rural processing module adjusting the property evaluation based on urbanization or rurality factors, and further assessing infrastructure development trends in a surrounding area, including transportation networks, utilities, and commercial developments, to adjust the property's evaluation based on potential future urbanization or rural preservation efforts for predictive modeling of long-term value shifts;
a township processing module configured to retrieve and verify property registration records from government databases, the township processing module ensuring compliance with legal and regulatory standards, identifying potential fraud or documentation discrepancies, and verifying property boundaries and ownership history using blockchain-based land registry systems to ensure tamper-proof records and account for any title disputes, thereby enhancing security and reliability in digital land record integration;
a secure messaging protocol, using a MQTT protocol, configured to transmit data between a bank server, the smart contract module, and machine learning modules, the secure messaging protocol ensuring secure and efficient communication during a property evaluation process, and further utilizing quantum-resistant encryption algorithms to ensure all communications remain secure against future cryptography-breaking technologies for low-latency, resilient data exchange in dynamic environments;
a secure access service edge (SASE) configured to monitor and control access to the system, the secure access service edge enforcing permissions and utilizing micro-segmentation techniques to protect sensitive financial and property-related data;
a spine-leaf network topology configured to connect the system components, including machine learning modules, smart contracts, and property databases, the spine-leaf network topology providing scalable, high-speed data transfers and minimizing latency during the property evaluation process to support simultaneous processing of multiple evaluations with reduced system complexity, wherein said spine-leaf network topology provides high-speed data transfers and minimizes latency, enabling the climate-impact analytics system to process multiple property evaluations simultaneously; and
a digital end-to-end transaction system configured to process and store all data related to property evaluations, the digital transaction system ensuring secure handling of property evaluation data from initial input to final loan or mortgage decision by incorporating adaptive risk assessments that optimize transaction resilience.

12. A climate-impact analytics method for evaluating loans and mortgages using a climate-impact analytics system, comprising:
receiving, by a control object algorithm, property data and environmental data from various sources, and dynamically routing the data based on the type of property being evaluated, including residential, commercial, industrial, or agricultural properties, to appropriate processing modules for analysis to improve data flow efficiency and enable specialized environmental risk evaluations;
processing, by the sliding window algorithm, continuous streams of time-series data, including temp, humidity, rainfall, and wind speed data, and reducing computational complexity by optimizing data analysis, while incorporating seasonal variations in climate data to predict environmental impacts on property values during different times of the year through transformation of nested loops into a single loop for real-time stream processing;
automating, by a smart contract module, secure data exchanges between financial institution systems and external data sources, and integrating with external regulatory databases to automatically retrieve and verify compliance with environmental laws and building codes during a property evaluation process to automate compliance and mitigate regulatory risks without human intervention;
analyzing, by an artificial neural network, historical and real-time environmental data to predict trends affecting property values, applying a backpropagation approach to improve evaluation accuracy over time, and utilizing convolutional layers to process geospatial imagery, thereby analyzing land features such as topography, vegetation, and proximity to water bodies for enhanced, context-specific predictive modeling;
generating, by a generative adversarial neural network, synthetic environmental scenarios, such as extreme weather events, to assess the property's resilience, and optimizing system performance by simulating network configurations to ensure secure and resilient data transmission by reinforcing defenses against potential security threats in financial data handling, wherein the generative adversarial neural network generates artificial scenarios to test the climate-impact analytics system's defenses;
integrating, by a climate environment information processing module, real-time updates from environmental monitoring systems with historical climate data, applying the sliding window algorithm to continuously reassess and generate a comprehensive evaluation of the property's environmental conditions for adaptive, continual reassessment that prevents performance degradation over time, wherein said real-time updates enables the climate-impact analytics system to dynamically adjust property valuations as new information becomes available;
assessing, by a urban/rural processing module, population density, economic activity, and land use patterns for properties, and adjusting the property evaluation based on urbanization or rurality factors, while further analyzing infrastructure development trends, including transportation networks and utilities, to assess future urbanization or rural preservation efforts to forecast long-term property value dynamics;
retrieving and verifying, by a township processing module, property registration records from government databases, ensuring compliance with legal and regulatory standards, identifying potential fraud or documentation discrepancies, and verifying property boundaries and ownership history using blockchain-based land registry systems to ensure tamper-proof records and address any title disputes for secure, verifiable digital record integration;
transmitting, by the secure messaging protocol using a MQTT protocol, data between a bank server, the smart contract module, and machine learning modules, and ensuring secure and efficient communication during the property evaluation process, while applying quantum-resistant encryption algorithms to safeguard communications against future cryptography-breaking technologies to achieve low-latency, secure data transfer in real-time evaluations;
monitoring and controlling, by a secure access service edge (SASE), access to the system, enforcing permissions and utilizing micro-segmentation techniques to protect sensitive financial and property-related data during the evaluation process;
connecting, by a spine-leaf network topology, system components, including machine learning modules, smart contracts, and property databases, providing scalable, high-speed data transfers and minimizing latency during the property evaluation process for efficient handling of high-volume datasets, wherein said spine-leaf network topology provides high-speed data transfers and minimizes latency, enabling the climate-impact analytics system to process multiple property evaluations simultaneously; and
processing, by a digital end-to-end transaction system, all data related to property evaluations, ensuring secure handling and storage of evaluation data from initial input to final loan or mortgage decision through resilient, adaptive transaction processing.

13. The method of claim 12, further comprising dynamically adjusting, by the control object algorithm, the routing of data based on changes in the type of evaluation required for specialized property types, including environmentally protected land, disaster-prone areas, or high-density urban regions, ensuring that specific environmental and legal factors are taken into account, and directing the data to additional modules for evaluating specific risks associated with these property types.

14. The method of claim 13, further comprising incorporating, by the sliding window algorithm, long-term climate change data, including rising sea levels, increasing frequency of extreme weather events, and changing temp patterns, into the property evaluation process, thereby predicting how future environmental risks may affect property values over a next 10 to 50 years, and providing a future risk assessment alongside a current evaluation.

15. The method of claim 14, further comprising automatically retrieving, by the smart contract module, updates from local, state, and federal government agencies and regulatory bodies regarding newly enacted building codes, environmental protection laws, land use regulations, or zoning changes that may influence the evaluation of the property, and adjusting the property evaluation in real-time to reflect these regulatory updates, ensuring that the property is compliant with the latest legal requirements.

16. The method of claim 15, further comprising analyzing, by the artificial neural network, multi-spectral satellite imagery alongside geospatial data to detect changes in land cover, such as deforestation, soil degradation, water body shifts, and urban sprawl, and using these changes as key factors in determining property suitability for development, agricultural use, or other activities, thereby providing a more granular and precise evaluation of the property's value and risk profile.

17. The method of claim 16, further comprising generating, by the generative adversarial neural network, multiple extreme environmental event scenarios, including natural disasters such as flooding, hurricanes, earthquakes, wildfires, and droughts, assessing how resilient the property is to each type of disaster, and adjusting the property value evaluation based on these simulations, including costs of potential damages, a recovery timeline, and insurance implications for each scenario.

18. The method of claim 17, further comprising continuously updating, by the climate environment information processing module, the property evaluation with real-time climate data obtained from IoT-connected environmental sensors, satellite-based monitoring systems, and weather stations, allowing the system to dynamically adjust the evaluation to reflect current environmental conditions, such as air quality, real-time precipitation levels, and storm severity, and how these immediate factors may influence the property's value at any given time.

19. The method of claim 18, further comprising assessing, by the urban/rural processing module, future infrastructure projects in the surrounding area, including planned expansions of road networks, public transportation, utility grids (such as electricity, water, and telecommunications), and other public services, using government and private sector data sources, and predicting how these developments will increase or decrease property future value, with particular focus on projected economic growth and urbanization trends.

20. The method of claim 19, further comprising verifying, by the township processing module, the property's historical ownership records across multiple jurisdictions, using distributed ledger technology or blockchain-based land registry systems to ensure tamper-proof and transparent records, identifying any discrepancies or fraudulent claims in the ownership history, and providing an adjusted evaluation if any disputes or irregularities are detected in a title history, thereby ensuring legal soundness of property ownership status before finalizing the loan or mortgage decision.
